(19) United States
(12) Patent Application Publication
(10) Pub. No.: US 2016/0005003 A1
(43) Pub. Date: Jan. 7, 2016

(54) Continuous Proximity and Relational Analysis of User Devices in a Network

(71) Applicant: RUBEYES INTANGIBLE HOLDINGS, LLC, Johns Island, SC (US)

(72) Inventors: Paul Valentine Norris, Johns Island, SC (US); Joshua Paul Norris, Johns Island, SC (US)

(21) Appl. No.: 14/768,901

(22) PCT Filed: Feb. 17, 2014
(86) PCT No.: PCT/US14/16709

§ 371 Date: Aug. 19, 2015

Related U.S. Application Data
(60) Provisional application No. 61/766,162, filed on Feb. 19, 2013.

(51) Int. Cl. G06Q 10/10; H04W 4/02; G06Q 50/00; H04L 29/06

(52) U.S. Cl. CPC G06Q 10/1095; H04L 65/403; H04W 4/021; G06Q 50/01

(57) ABSTRACT

A system includes receiving, from a user device, an instruction to create a meeting. The instruction may identify another user device to invite to the meeting, or a geographic area in which the meeting occurs. The system may also include transmitting, to the other user device, a request to attend the meeting; identifying a communication state, of the other user device, that indicates whether providing location information, associated with the other user device, to the user device is permitted; obtaining the location information when the state permits providing the location information; determining whether the other user device is located within the area based on the location information; and transmitting, to the user device, a notification that indicates that the other user device is within the area when the other user device is within the area. The notification including the location information when the state permits providing the location information.

### REFERENCE TO RELATED APPLICATION

This application claims priority to U.S. Provisional Patent Application No. 61/766,162, filed Nov. 19, 2013, the entire contents of the provisional application being incorporated herein by reference.

### BACKGROUND

Computing and communication devices are capable of performing an increasing variety of functions and tasks that continue to improve the user's experience. For example, computing and communication devices can run a variety of applications, can connect to a variety of wired and wireless networks to receive services, can perform point of sale transactions to purchase goods and/or services, and/or can download content, which can be stored and/or displayed on the computing and communicating devices. In one specific example, computing and communication devices can perform social networking by accessing websites that provide social networking services that enable users, of the computing and communications devices, to socially interact with each other using the computing and communication devices. Such social networking services may not, however, always permit or encourage users to socially interact directly at a particular location or in-person on a face-to-face basis without using the computing and communications devices. In a recent appearance on CBS This Morning®, Brian Cooley, editor-at-large at CNET®, indicated that recent advances in mobile technology and networking as resulted in the “continued de-socialization of America.”

### SUMMARY

According to one implementation, described herein, a method may include receiving, by a server device and from a first user device, an instruction to create a meeting event. The instruction may identify at least one of: a second user device that is to be invited to attend the meeting event, or a geographic area in which the meeting event is to occur. The method may also include transmitting, by the server device and to the second user device, a request to attend the meeting event based on receiving the instruction; identifying, by the server device and based on transmitting the request, a communication state of the second user device. The communication state may indicate whether location information, that identifies a location of the second user device, is to be provided to the first user device. The method may further include obtaining, by the server device, the location information when the communication state indicates that the location information is to be provided to the first user device; determining, by the server device and based on the location information, whether the second user device is located within the geographic area; an transmitting, to the first user device, a notification that indicates that the second user device is located within the geographic area, when the second user device is located within the geographic area. The notification may include the location information when the communication state indicates that the location information is permitted to be provided to the first user device.

According to another implementation a server device may include one or more processors, executing one or more instructions, to receive, from a first user device, an instruction to create a meeting event. The instruction including meeting information that identifies at least one of: a second user device to be invited to attend the meeting event, a distance associated with a location where the meeting event is to occur, or a time when the meeting is to occur. The one or more processor may also transmit, to the second user device, a request to attend the meeting event based on the instruction; obtain, based on transmitting the request, context information, associated with the second user device, that identifies a communication state of the second user device. The communication state may indicate whether location information, that identifies a location of the second user device, is permitted to be obtained or is permitted to be provided to the first user device. The one or more processors may further determine whether an amount of time, before the meeting time, is less than a predetermined threshold when the communication state indicates that the location information is permitted to be obtained; obtain the location information when the amount of time is less than the threshold; determine, by the server device and based on the location information, whether the second user device is located within the distance associated with the location; and transmit, to the first user device, a notification that indicates that the second user device is located within the distance when the second user device is located within the distance. The notification may include the location information when the communication state indicates that the location information is permitted to be provided to the first user device.

According to a further implementation, a non-transitory computer-readable medium, containing one or more instructions executable by one or more processors, may include one or more instructions to receive, from a first user device, a request to create a zone, the request including zone information that identifies a geographical area associated with the zone; and one or more instructions to determine, based on the zone information, whether a first type of zone or a second type of zone is to be created. The first type of zone may enable a notification to be provided, to the first user device, when a particular user device is located within the zone, and the second type of zone may preclude the notification from being provided, to the first user device, when the particular user device is located within the geographical area. The non-transitory computer-readable medium may also include one or more instructions to determine that a second user device is located within the geographic area based on determining whether the first type of zone or the second type of zone is to be created; one or more instructions to determine whether the second user device is identified by the zone information, based on the determination that the second user device is located within the geographic area; and one or more instructions to provide, to the first user device, the notification, that indicates that the second user device is located within the geographical area, when the second user device is identified by the zone information and when the first type of zone is to be created.

According to another implementation a method may include receiving, by a server device and from a first user device, an instruction to create a meeting event. The instruction may include meeting information that identifies at least one of: a second user device to be invited to attend the meeting event, or a geographic area in which the meeting event is located. The method may also include transmitting, by the server device and to the second user device, a request to attend the meeting event based on receiving the instruction; determining, by the server device and based on transmitting the request, whether a response, to the request, is received from the second user device; transmitting, to the first user device, the response when the response is received from the second user device, the response indicating that the second user device is not attending the meeting event, is attending the meeting event, or that attendance at the meeting event is tentative; and determining, by the server device, a communication state associated with the second user device when the response indicates that the second user device is attending the meeting event. The communication state may indicate at least whether location information, that identifies a location of the second user device, is permitted to be obtained. The method may further include obtaining, by the server device, the location information when the communication state indicates that the location information is permitted to be obtained by the server device; determining, by the server device and based on the location information, whether the second user device is located within the geographical area; and transmitting, to the first user device, a notification that indicates that the second user device is located within the geographical area.

### BRIEF DESCRIPTION OF THE DRAWINGS

FIG. 1 is a diagram illustrating an overview of an example implementation described herein;

FIG. 2 is a diagram of an example environment in which systems and/or methods described herein may be implemented;

FIG. 3 is a diagram of example components of one or more of the devices of FIG. 2;

FIG. 4 is a diagram of an example user device, as shown in FIG. 2;

FIG. 5 is a flow chart of an example process to register the user device of FIG. 2 and/or set up a continuous proximity and relational analysis application according to an implementation described herein;

FIGS. 6A & 6B are diagrams of example user interfaces for setting up a continuous proximity and relational analysis application;

FIG. 7 is a flow chart of an example process to set a communication state, of a user device of FIG. 2, to enable location information to be transmitted to another user device of FIG. 2 according to an implementation described herein;

FIG. 8 is a diagram of an example user interface 800 that identifies a list of contacts associated with a user device of FIG. 2;

FIG. 9 is a diagram of an example user interface that identifies a respective location and/or communication state of a selected contact associated with a user device 210 of FIG. 2;

FIG. 10 is a diagram of user devices in various user-defined communications states that may be used to control the manner in which information, associated with a location of a user device, is transmitted;

FIG. 11 is a flowchart of an example process to create, track, and/or manage a geographical zone with which to monitor, manage or preclude the relative proximity of a user device according to an implementation described herein;

FIGS. 12A and 12B are example user interfaces that can be used to create, track, or manage a zone or quiet zone created by a user device of FIG. 2;

FIG. 13 is a flow chart of an example process to create, track, and/or manage a meeting event according to an implementation described herein;

FIGS. 14A through 14D are example user interfaces that can be used to create, track, or manage a meeting event created by a user device and/or a server device of FIG. 2; and

FIG. 15 is a flowchart of an example process to identify a measure of relevance for use in determining whether to invite, and/or provide content to, a user device according to an implementation described herein.

### DETAILED DESCRIPTION OF PREFERRED EMBODIMENTS

The following detailed description refers to the accompanying drawings. The same reference numbers in different drawings may identify the same or similar elements.

Systems and/or methods, described herein, may enable a user device and/or a server device to create, track, and/or manage a meeting event at a location and/or time that is specified by a user of the user device. The first user device and/or server device may use an application that enables a continuous proximity and relational analysis (CPRA) operation to be performed (hereinafter, “CPRA application”), on another user device, to dynamically identify and track the relative location, distance, arrival times, communications with, user intentions, environmental conditions (e.g., traffic, weather, etc.), and/or context information (described below) associated with the other user device that has been invited to attend the meeting event.

The systems and/or methods may, for example, enable a first user device to transmit, to a second user device, a request to attend a meeting event. The systems and/or methods may enable the first user device and/or a server device, using the CPRA application, to dynamically determine, track, and/or update the location of the second user device to determine a geographic and/or spatial proximity (e.g., travel distance, radial distance, three-dimensional distance, speed, acceleration, etc.) of the second user device (subject to the explicit consent of a user of the second user device as described in greater detail herein) relative to the location, geographic area, and/or time associated with the meeting event. The systems and/or methods may also, or alternatively, enable a distance and/or estimated travel time, projected time of arrival, etc. of the second user device, to the meeting event to be determined, tracked, and/or updated based on the relative change in location or spatial proximity and/or environmental conditions (e.g., traffic patterns, transportation routes, weather conditions, etc.) associated with the second user device.

The systems and/or methods may also, or alternatively, enable a first user device and/or a server device, using the CPRA application, to determine whether a response, to a request to attend a meeting event, has been received and/or if such a response indicates that the request has been accepted, tentatively accepted, rejected, etc. The systems and/or methods may provide one or more other notifications to the first user device that updates the distance, travel time, environmental conditions (e.g., traffic patterns, weather conditions, accident reports, etc.) of the second user device to the location and/or to indicate that the second user device has arrived at the meeting event.

The systems and/or methods may also, or alternatively, enable a server device to provide a notification (hereinafter referred to as a “proximity alert”) to a first user device when a second user device meets certain criteria, such as being located within a certain distance from and/or travel time to the first user device based on a user-specified proximity setting (e.g., distance, radius, time, date, boundary, perimeter, etc.) relative to a location of the first user device, and/or a measure of relevance between context information associated with the first user device and context information associated with the second user device.

The systems and/or methods may also, or alternatively, enable a user device and/or server device, using the CPRA application, to create a zone, associated with a user-specified geographic area, that enables the user device to receive notifications when a selected other user device enters or exits the geographical area. The systems and/or methods may, for example, enable a first user device and/or server device to identify a zone associated with a geographic area in which a meeting event is located, the first user device is located, and/or at some other location (e.g., a school, a church, a place of employment, etc.). The shape, size, area, perimeter, boundaries, circumference, radius and/or other dimensions of the zone may be specified by the user of the first user device using a proximity setting associated with the zone. As described herein, the zone will be described as having a circular shape based on a user-specified proximity radius for explanatory purposes. In practice, the zone may not be so limited and may assume any shape as specified by the user. The systems and/or methods may also, or alternatively, provide a proximity alert to a first user device that indicates that a second user device, that the user has associated with the zone, has entered or exited the zone. Additionally, or alternatively, the systems and/or methods may provide a proximity alert when a third user device, not invited to a meeting with which the zone is associated, is within the zone. The proximity alert may enable the first user device to provide a request to the third user device to attend the meeting event.

The systems and/or methods may also, or alternatively, enable the user device and/or server device, using the CPRA application, to create a quiet zone, associated with a user-specified geographic area, that precludes proximity alerts and/or other information (e.g., location information, messages, etc.) from being received from other user devices that enter or exit the geographic area. The user may, however, specify a particular excepted user device for which proximity alerts are to be received when the excepted user device enters or exits the geographical area. A quiet zone may, for example, be created at a location that corresponds to the home, office, etc. of the user to preclude frequent proximity alerts from being received (e.g., such as when a neighbor or co-worker user device enters or exits the zone), while preserving proximity alerts for a certain, excepted user device (e.g., an excepted user device of a spouse, a supervisor, a child, etc.). Such a quiet zone may avoid the potential nuisance of repeatedly receiving proximity alerts under conditions that the user does not desire to receive such alerts.

The systems and/or methods may also, or alternatively, enable a first user device and/or server device to obtain context information, associated with a first user device. Context information may be obtained from the first user device and/or from registration information that is provided by the user when registering the first user device. The context information, may include information associated with the user (e.g., a name, an address, a username, a personal identification number (PIN), a password, etc.) and/or the first user device (e.g., a device identifier, etc.), hobbies and/or interests of the user, preferences of the user (e.g., favorite movies, books, parental controls, group memberships, etc.), usage history of the user (e.g., frequency of use CPRA application, occasions of prior use of the CPRA application, specific services used via the CPRA application, duration of prior uses of the CPRA application, browsing habits of the user, etc.) and/or purchase history of the user, proximity settings of the first user device set by the user, a communication state (described below) of the first user device, identification of current or prior meeting events, zones, quite zones, etc. All or a portion of the context information may be based on registration information, provided by the user device, when the user device is registered with the application server. The system and/or methods may enable the context information to be dynamically and/or automatically updated, over time, as, for example, communications states change, usage history changes, proximity settings change, etc. The systems and/or methods may compare first context information, associated with the first user device, to second context information, associated with a third user device to determine a degree of match and/or measure of relevance between the first and second context information. If the degree of match and/or measure of relevance is sufficient (e.g., greater than a threshold), the systems and/or methods may provide a notification, to the first user device, that suggests that a request, to attend the meeting, be provided to the third user device. Additionally, or alternatively, in the case when the first user device is associated with a business, the systems and/or methods may provide an invitation, a notification, advertising content, promotional material, a discount, etc. to the third user device based on the context information identifying prior usage (e.g., indicating that third user device is a prior and/or frequent visitor to, and/or purchaser from, the business). The systems and/or methods may also, or alternatively, determine respective spatial proximities, degrees of match, and/or measures of relevance between the first user device and one or more other user devices and may associate scores with the one or more other user devices based on the respective spatial proximities, degrees of match and/or measures of relevance. The systems and/or methods may select none, some, or all of the other user devices based on the scores and may provide a notification to the user device that recommends that one or more requests, to attend a meeting event, be sent to the selected other user devices.

The systems and/or methods may enable user-specified states of communication (hereinafter, “communication states”) to be set and consented to regarding the location of a user device. For example, when a user sets a first user device to a first communication state, no information, that identifies the location (e.g., latitude, longitude, street address, zip code, etc.) of the first user device (hereinafter, “location information”), may be communicated to a second user device (hereinafter referred to as the “offline state” or being “offline”). Additionally, or alternatively, when the first user device is not in the offline state and the user sets the first user device to a second communication state, the location information associated with the first user device may not be transmitted to the second user device, but a proximity alert may be provided to the second user device when the first user device is within a particular distance, proximity, and/or travel time of the second user device based on proximity settings of the second user device (hereinafter referred to as an “invisible state” or being “invisible”). Additionally, or alternatively, when the first user device is not offline and the user sets the first user device to a third communication state, a proximity alert may be provided to the second user device when the first user device is within a particular distance, proximity, and/or travel time of the second user device, and the location information may, or may not, be transmitted to the second user device (hereinafter referred to as the “visible state” or being “visible”). Whether or not the location information is transmitted may depend on whether the transmission of the location information is explicitly authorized by the user. If, for example, the first user device is in the visible state, the user may authorize the location information to be selectively transmitted to the second user device (hereinafter, referred to as the “plugged in state” or being “plugged in”) but not to a third user device to which the first user device is not plugged in (hereinafter referred to as the “unplugged state” or being “unplugged”). The plugged in state may enable the location information to be received and/or displayed by only the second user device for viewing by the user of the second user device. Additionally, or alternatively, the user may set the communication state of the user device that enables location information, associated with the user device, to be made available, on a non-selective bases, to one or more other user devices without specifically plugging in to each of the other user devices (hereinafter referred to as a “fully visible state” or being “fully visible”).

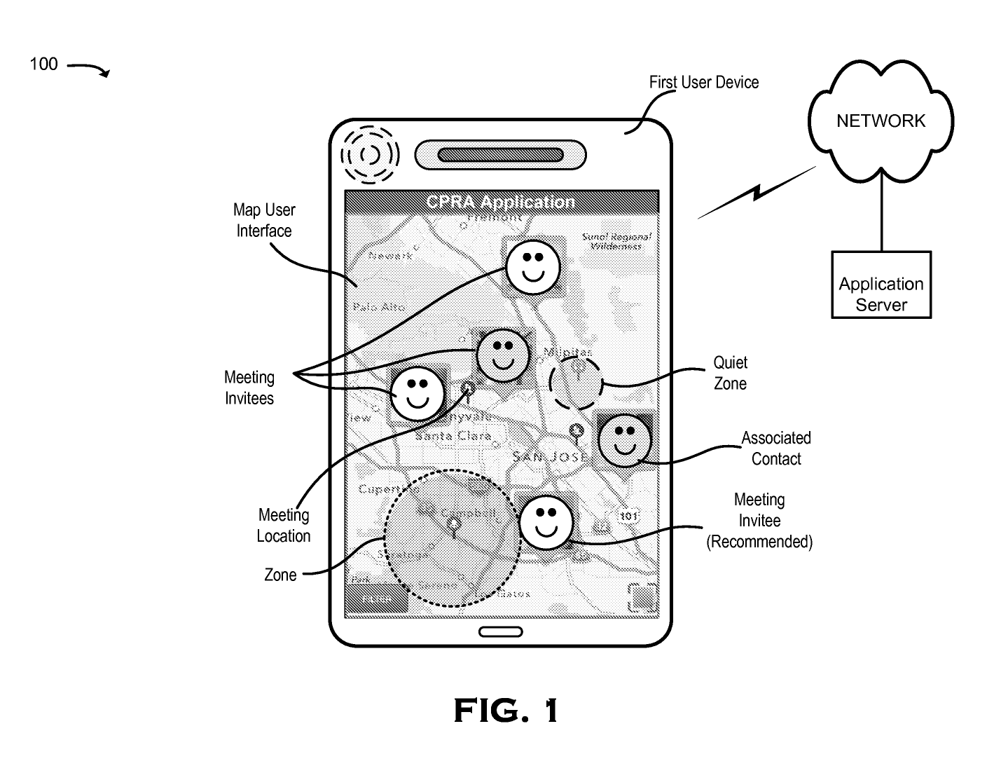

FIG. 1 is a diagram of an example overview 100 of an example implementation described herein. As shown in FIG. 1, a first user device may communicate with an application server via a network. The first user device may execute a continuous proximity and relational analysis (CPRA) application to associate a contact, of a first user of the first user device, with the first user device. The CPRA application may, for example, cause the application server to provide a copy of the CPRA application to the second user device with which the contact is associated. The CPRA application may enable the first user to specify a communication state, of the first user device, that enables the first user to control and/or manage the manner in which first location information, that identifies a location of the first user device, is obtained, tracked, and/or provided to the second user device. The CPRA application may enable the first user device to display information, via a user interface (e.g., shown as “map user interface” in FIG. 1), associated with a geographical area in which the first user device is located.

The CPRA application may display, via the map user interface, an indication that identifies a second location of the second user device (e.g., shown as “associated contact”) when a communication state, of the second user device, permits identification of the second location to be provided to the first user device. The CPRA application may enable the first user device to receive a notification when the second user device is within a first distance of the first user device. The first distance may be specified by the first user.

The CPRA application may enable the user to create a meeting event associated with a meeting location (e.g., shown as “Meeting Location” within the map user interface) to which one or more contacts, associated with one or more third user devices, can be invited. The CPRA application may enable the first user device to communicate with the third user devices to determine whether the users, of the third devices, intend to attend the meeting event. The CPRA application may enable the first user device to detect, track, and/or monitor respective locations of the third user devices relative to the meeting location, when respective communication states, of the third user devices, permit respective locations, of the third user devices, to be provided to the first user device. The CPRA application may enable the first user device to receive information, that identifies the location of each of the third user devices, if communication states, of each of the third user devices, permit the information to be provided to the first user device (shown as “Meeting Invitees” in the map user interface). The CPRA application may also, or alternatively, enable the first user device to receive a notification, advertising content, promotional information, etc. when a third user device is within a second distance of the meeting location based on the communication states of the third user devices. The second distance may be specified by the first user.

The CPRA application may enable first user device to receive a notification that identifies a recommended invitee to the meeting event based on a measure of relevance between a user of a fourth user device (e.g., based on the preferences of the user, user's hobbies, interests, group memberships, prior purchase, prior browsing habits, etc.) and the description of the meeting event. The measure of relevance may correspond to a degree to which the user's hobbies, interest, etc. match the meeting description. In the event that the first user desires the recommended invitee to attend the meeting event, the CPRA application may cause a request, to attend the meeting event, to be provided to the fourth user device (e.g., shown as “Meeting Invitee (Recommended).”

The CPRA application may also, or alternatively, enable the first user device to create a zone associated with a user-specified geographic area (e.g., identified by the shaded circle and dashed circumference labeled “Zone”), that enables the first user device to receive a notification when a user-specified user device enters or exits the geographical area. The CPRA application may also, or alternatively, enable the first user device to create a quiet zone (e.g., identified by the shaded circle and dashed circumference labeled “Quiet Zone”), associated with a user-specified geographic area, that precludes a notification and/or other information (e.g., location information, messages, etc.) from being received from another user device that enters or exits the geographic area. The first user may, however, specify a particular excepted user device for which notifications and/or other information are to be received when the excepted user device enters or exits the geographical area.

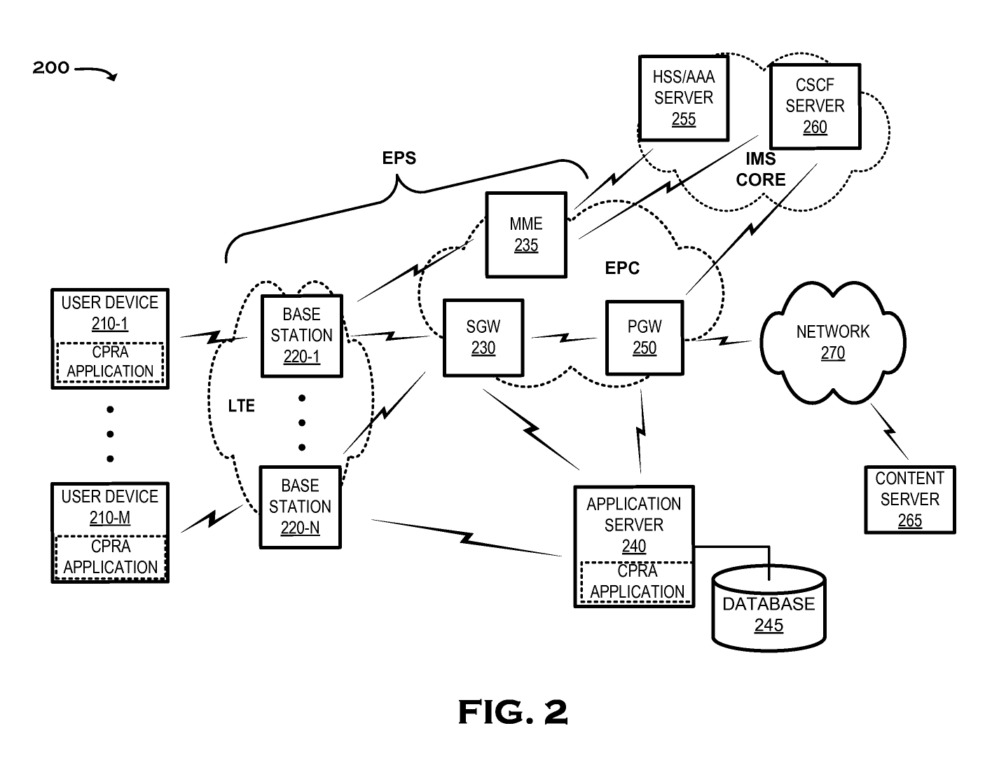

FIG. 2 is a diagram of an example environment 200 in which systems and/or methods described herein may be implemented. As shown in FIG. 2, environment 200 may include a group of user devices 110-1, . . . , 110-M (where M≧1) (hereafter referred to collectively as “user devices 210” and each, a “user device 210”), a group of base stations 220-1, . . . , 220-N (where N≧1) (hereinafter referred to collectively as “base stations 220” and individually as “base station 220”), a serving gateway 230 (hereinafter referred to as “SGW 230”), a mobility management entity device 235 (hereinafter referred to as “MME 235”), an application server 240, a database 245, a packet data network (PDN) gateway (PGW) 250, a home subscriber server (HSS)/authentication, authorization, accounting (AAA) server 255 (hereinafter referred to as an “HSS/AAA server 255”), a call session control function (CSCF) server 260 (hereinafter referred to as “CSCF server 260”), a content server 265, and a network 270. The number of devices and/or networks, illustrated in FIG. 2, is provided for explanatory purposes only. In practice, there may be additional devices and/or networks; fewer devices and/or networks; different devices and/or networks; or differently arranged devices and/or networks than illustrated in FIG. 2.

Also, in some implementations, one or more of the devices of environment 200 may perform one or more functions described as being performed by another one or more of the devices of environment 200. Devices of environment 200 may interconnect via wired connections, wireless connections, or a combination of wired and wireless connections.

Implementations described herein are described as being performed within a radio access network (RAN) that is based on a long term evolution (LTE) network for explanatory purposes. In other implementations, the implementations may be performed within a RAN that is not based on a LTE network.

Environment 200 may include an evolved packet system (EPS) that includes a LTE network and/or an evolved packet core (EPC) that operate based on a third generation partnership project (3GPP) wireless communication standard. The LTE network may be a RAN that includes one or more base stations 220 that take the form of evolved Node Bs (eNBs) via which user devices 210 communicate with the EPC. The EPC may include SGW 230, MME 235, and/or PGW 250 that enable user devices 210 to communicate with network 270 and/or an Internet protocol (IP) multimedia subsystem (IMS) core. The IMS core may include HSS/AAA server 255 and/or CSCF server 260 and may manage authentication, session initiation, account information, profile information, etc. associated with user devices 210.

User device 210 may include any computation or communication device, such as a wireless mobile communication device that is capable of communicating with base station 220 and/or a network (e.g., network 270). For example, user device 210 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a laptop computer, a tablet computer, a camera, a personal gaming system, or another type of mobile computation or communication device that is capable of sending traffic to and/or receiving traffic from the network 270. Additionally, or alternatively, user device 210 may include a desktop computer, a landline telephone, an appliance, a set top box, and/or other communication or communication device that is capable of communicating with network 270. In one example implementation, user device 210 may include a global positioning satellite (GPS) component that communicates with a GPS constellation to obtain location information associated with user device 210.

In another example implementation, user device 210 may host a CPRA application to perform operations, such as continuous proximity and relational analysis operations, as described herein. The CPRA application may enable user device 210 to access application server 240 in a secure manner via an application programming interface (API) and/or a secure protocol (e.g., a tunneling protocol, a hypertext transfer protocol secure (HTTPS), a secure sockets layer (SSL), an Internet Protocol Security (IPsec), and/or some other secure protocol). User device 210 may also, or alternatively, communicate with application server 240 to download and/or register the CPRA application and/or user device 210. The CPRA application may permit user device 210 to obtain information associated with other user devices 210, import contacts (e.g., information associated with friends of the user and other user devices 210 with which the friends are associated), set up a profile (e.g., preferences, hobbies, communications states, proximity settings etc.). The CPRA application may also, or alternatively, enable user device 210 to associate another user device 210 with which a contact is associated to enable location information, context information, and/or other information to be provided to and/or received from the other user device 210.

User device 210 may use the CPRA application to create, track, and/or manage meeting events, zones, and/or quiet zones based on user input and may communicate with application server 240 transmit and/or receive information that enables such meeting events, zones, and/or quiet zones to be created, tracked, and/or managed with respect to the proximity, location, etc. of other user devices 210. Additionally, or alternatively, the CPRA application may enable a proximity setting, for user device 210, to be set by the user; a communication state, for user device 210, to be authorized by the user; and/or communications (e.g., messages, images, video, etc.) regarding a meeting event, whether or not a contact is attending a meeting event, and/or some other topic to be transmitted to and/or received from another user device 210.

Base station 220 may include one or more devices that receive, process, and/or transmit traffic, such as audio, video, text, and/or other data, destined for and/or received from user device 210. In an example implementation, base station 220 may be an eNB associated with the LTE network that receives traffic from and/or sends traffic to network 270 via SGW 230 and PGW 250. Base station 220 may send traffic to and/or receive traffic from user device 210 via an air interface. In another example, one or more other base stations 220 may be associated with a RAN that is not associated with the LTE network.

Base station 220 may transmit information associated with traffic load conditions, bandwidth capacity, etc. to SGW 230 and/or application server 240 to permit a load balancing and/or some other operation to be performed to maintain a sufficient bandwidth and/or quality of service levels. Base station 220 may also, or alternatively, provide location information to application server 240, SGW 230, and/or MME 235 that indicates that a particular user device 210 is communicating via base station 220, a particular cell associated with base station 220, etc.

SGW 230 may include one or more computation or communication devices that gather, process, search, store, and/or provide information in a manner described herein. SGW 230 may include one or more data processing and/or traffic transfer devices, such as a gateway, a router, a modem, a switch, a firewall, a network interface card (NIC), a hub, a bridge, a proxy server, an optical add-drop multiplexer (OADM), or some other type of device that processes and/or transfers traffic. In one example implementation, SGW 230 may aggregate traffic received from one or more base stations 220 associated with the LTE network, and may send the aggregated traffic to network 270 (e.g., via PGW 250) and/or other network devices associated with the IMS core and/or the EPC. SGW 230 may also receive traffic from the other network devices and/or may send the received traffic to user device 210 via base station 220. SGW 230 may perform operations associated with handing off user device 210 from and/or to the LTE network. SGW 230 may also, or alternatively, provide location information, associated with user device 210, to application server 240.

MME 235 may include one or more computation or communication devices that gather, process, search, store, and/or provide information in a manner described herein. For example, MME 235 may perform operations associated with handing off user device 210, from a first base station 220 to a second base station 220, when user device 210 is exiting a cell associated with the first base station 220. MME 235 may, in yet another example, perform an operation to handoff user device 210 from the second base station 220 to the first base station 220 when user device 210 is entering the cell associated with first base station 220.

Application server 240 may include one or more computation or communication devices that gather, process, search, store, and/or provide information in a manner described herein. For example, application server 240 may host and/or execute a CPRA application to perform operations, such as continuous proximity and relational analysis operations, as described herein. Application server 240 may communicate with user device 210 to register user device 210 and/or to provide and/or register a copy of CPRA application that is compatible with and/or supported user device 210. Application server 240 may authenticate user device 210 and/or a user of user device 210 to enable user device 210 to access services provided by application server 240. Application server 240 may use the CPRA application to communicate with user device 210, via base station 220, SGW 230, and/or PGW 250 in a secure manner via, for example, an API and/or a secure protocol (e.g., a tunneling protocol, HTTPS, SSL, IPsec, and/or some other secure protocol).

Application server 240 may communicate with content server 265 to access contacts, of the user of user device 210, via an application used by user device 210 and hosted by content server 265 (e.g., Facebook®, Google®, Twitter®, etc.). Application server 240 may provide information, associated with the contacts, to user device 210. Application server 240 may use the CPRA application to communicate with user device 210 to create, track, and/or manage meeting events, zones, and/or quiet zones created by user device 210.

Application server 240 may obtain, from user device 210, context information associated with user device 210 and/or a profile associated with the user of user device 210 and may store the context information and/or profile in a memory associated with application server 240 (e.g., database 245, etc.). Application server 240 may use the context information to create, track, and/or manage meeting events, zones, and/or quiet zones; to determine a communication state of user device 210; to identify a proximity radius set by the user; to identify another user device 210 with context information that most closely matches the context information (e.g., to suggest associating as a contact, inviting to a meeting event, etc.), etc.

Application server 240 may obtain location information and/or context information, associated with another user device 210 that is invited to attend a meeting event and/or associated with a zone created by user device 210. Application server 240 may provide a proximity alert and/or the location information, to user device 210, when the other user device 210 is within a user-specified distance, proximity, or arrival time of user device 210 and/or meeting event. Additionally, or alternatively, application server 240 may provide the proximity alert and/or the location information to user device 210 when application server 240 determines that the context information, associated with the other user device 210, authorizes the proximity alert and/or location information to be provided to user device 210.

Database 245 may include one or more devices that store information received from application server 240. For example, database 225 may store copies CPRA applications that are supported by and/or compatible with different types of user devices 210; context information associated with user device 210; location information associated with user device 210; information associated with a profile of a user of user device 210; information associated with contacts of the user of user device 210; information associated with meeting events, zones, quiet zones, etc. created by user device 210; scores associated with measures of relevance and/or degree of match between difference context information; etc.

PGW 250 may include one or more computation or communication devices that gather, process, search, store, and/or provide information in a manner described herein. PGW 250 may include one or more data processing and/or traffic transfer devices, such as a gateway, a router, a modem, a switch, a firewall, a NIC, a hub, a bridge, a proxy server, an OADM, or some other type of device that processes and/or transfers traffic. In one example implementation, PGW 250 may include a device that aggregates traffic received from one or more SGWs 230, etc. and may send the aggregated traffic to network 270. In another example implementation, PGW 250 may receive traffic from network 270 and may send the traffic toward user device 210 via SGW 230 and/or base station 220.

HSS/AAA server 255 may include one or more server devices, or other types of computation or communication devices, that gather, process, search, store, and/or provide information in a manner described herein. For example, HSS/AAA server 255 may manage, update, and/or store, in a memory associated with HSS/AAA server 255, profile information associated with user device 210 that identifies applications and/or services that are permitted for and/or accessible by user device 210, information associated with a user of user device 210 (e.g., a username, a password, a personal identification number (PIN), etc.), rate information, minutes allowed, and/or other information. Additionally, or alternatively, HSS/AAA server 255 may include a device that performs authentication, authorization, and/or accounting (AAA) operations associated with a communication session with user device 210.

CSCF server 260 may include one or more server devices, or other types of computation or communication devices, that gather, process, search, store, and/or provide information in a manner described herein. CSCF server 260 may process and/or route calls to and from user device 210 via the EPC. For example, CSCF server 260 may process calls, received from network 270, that are destined for user device 210. In another example, CSCF server 260 may process calls, received from user device 210, that are destined for network 270.

Content server 265 may include one or more server devices, or other types of computation or communication devices, that gather, process, search, store, and/or provide information in a manner described herein. Content server 265 may, for example, provide a social networking service and/or content (e.g., Facebook®, Google®, Twitter®, etc.); a service that provides information associated with environmental conditions (e.g., traffic conditions, weather conditions, accident alerts, etc.) with respect to a geographic area; and/or some other content and/or service that can be accessed by application server 240. Additionally, or alternatively, content server 265 may include any type or form of content provider.

Network 270 may include one or more wired and/or wireless networks. For example, network 270 may include a cellular network, a public land mobile network (PLMN), a second generation (2G) network, a 3G network, a 4G network, a fifth generation (5G) network, and/or another network. Additionally, or alternatively, network 270 may include a wide area network (WAN), a metropolitan area network (MAN), a telephone network (e.g., the Public Switched Telephone Network (PSTN)), an ad hoc network, an intranet, the Internet, a fiber optic-based network (e.g., FiOS), and/or a combination of these or other types of networks.

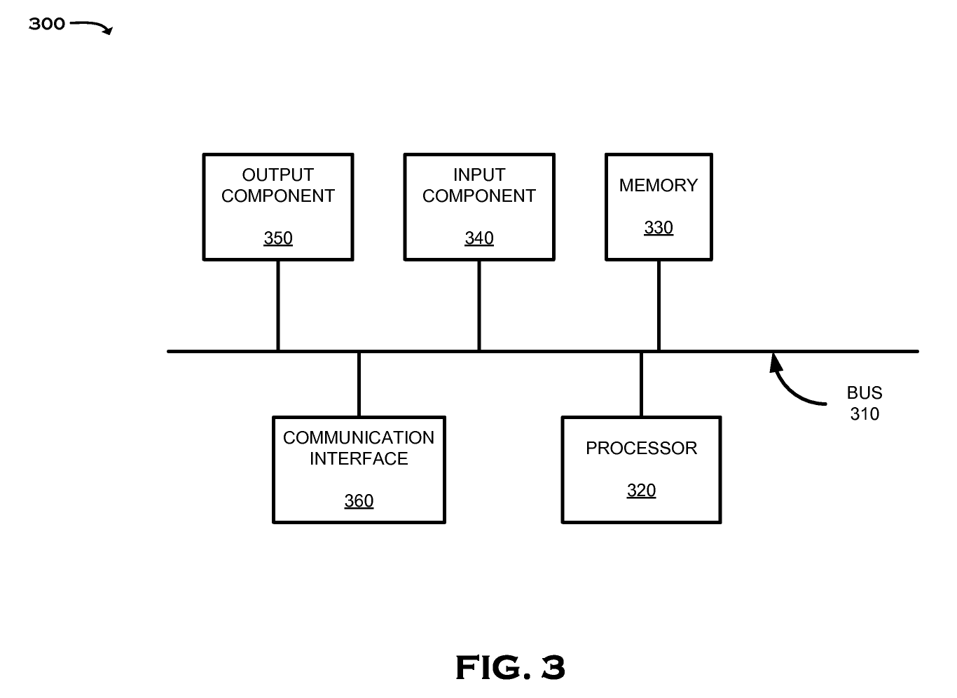

FIG. 3 is a diagram of example components of a device 300 that may correspond to user device 210, application server 240, SGW 230, PGW 250, MME 235, HSS/AAA server 255, CSCF server 260 and/or content server 265. Additionally, or alternatively, each of user device 210, application server 240, SGW 230, PGW 250, MME 235, HSS/AAA server 255, CSCF server 260 and/or content server 265 may include one or more devices 300. Device 300 may include a bus 310, a processor 320, a memory 330, an input component 340, an output component 350, and a communication interface 360. Although FIG. 3 shows example components of device 300, in other implementations, device 300 may include fewer components, additional components, different components, or differently arranged components than depicted in FIG. 3. Additionally, or alternatively, in other implementations, one or more components of device 300 may perform one or more tasks described as being performed by one or more other components of device 300.

Bus 310 may include a path that permits communication among the components of device 300. Processor 320 may include a processor, microprocessor, or processing logic that may interpret and execute instructions. Memory 330 may include any type of dynamic storage device that may store information and instructions for execution by processor 320, and/or any type of non-volatile storage device that may store information for use by processor 320.

Input component 340 may include a mechanism that permits an operator to input information to device 300, such as a keyboard, a keypad, a button, a switch, etc. Output component 350 may include a mechanism that outputs information to the operator, such as a display, a speaker, one or more light emitting diodes (LEDs), etc. Communication interface 360 may include any transceiver-like mechanism that enables device 300 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.) or a combination of wireless and wired communications. For example, communication interface 360 may include mechanisms for communicating with another device or system via a network, such as network 270.

As will be described in detail below, device 300 may perform operations relating to continuous proximity and relational analysis. Device 300 may perform these operations in response to processor 320 executing software instructions contained in a computer-readable medium, such as memory 330. A computer-readable medium may be defined as a non-transitory memory device. A memory device may include space within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of or in combination with software instructions to implement processes described herein. Thus, implementations described herein are not limited to any specific combination of hardware circuitry and software.

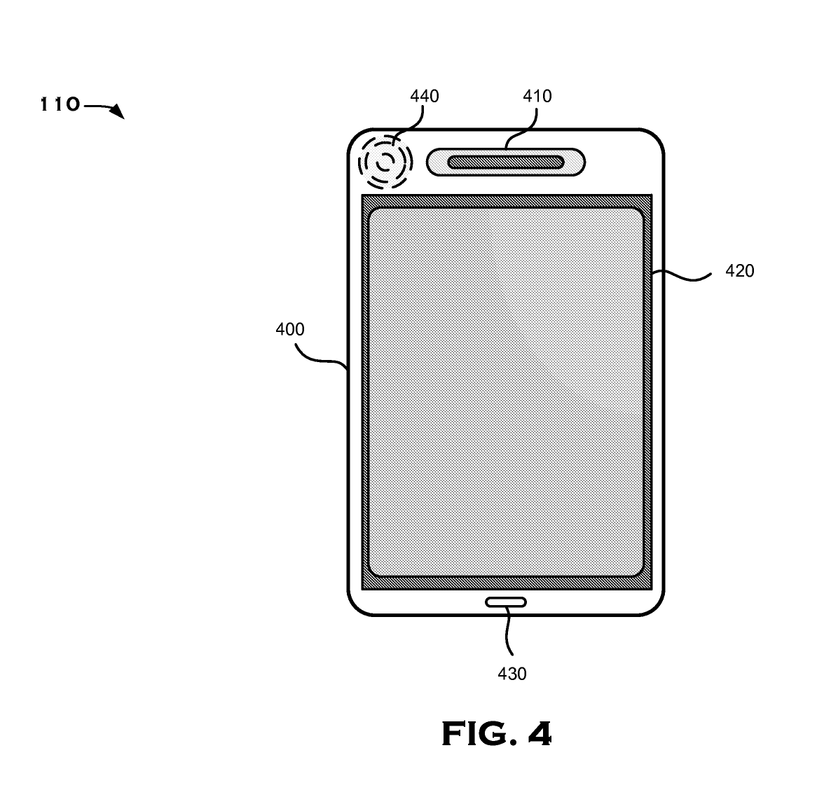

FIG. 4 is a diagram of an example user device 210. As shown in FIG. 4, user device 210 may include a housing 400, a speaker 410, a display 420, a microphone 430, and/or a camera 440. Housing 400 may include a chassis via which some or all of the components of user device 210 are mechanically secured and/or covered. Speaker 410 may include a component to receive input electrical signals from user device 210 and transmit audio output signals, which communicate audible information to a user of user device 210.

Display 420 may include a component to receive input electrical signals and present a visual output in the form of text, images, videos and/or combinations of text, images, and/or videos which communicate visual information to the user of user device 210. In one implementation, display 420 may display text input into user device 210, text, images, and/or video received from another device, and/or information regarding incoming or outgoing calls or text messages, emails, media, games, phone books, address books, the current time, etc.

Display 420 may be a touch screen that presents one or more images that corresponds to control buttons. The one or more images may accept, as input, mechanical pressure from the user (e.g., when the user presses or touches an image corresponding to a control button or combinations of control buttons) and display 420 may send electrical signals to processor 220 that may cause user device 210 to perform one or more operations. For example, the control buttons may be used to cause user device 210 to transmit information. Display 420 may present one or more other images associated with a keypad that, in one example, corresponds to a standard telephone keypad or another arrangement of keys.

Microphone 430 may include a component to receive audible information from the user and send, as output, an electrical signal that may be stored by user device 210, transmitted to another user device, or cause the device to perform one or more operations. Camera 440 may be provided on a front or back side of user device 210, and may include a component to receive, as input, analog optical signals and send, as output, a digital image or video that can be, for example, viewed on display 420, stored in the memory of user device 210, discarded and/or transmitted to another user device 210.

Although FIG. 4 depicts example components of user device 210, in other implementations, user device 210 may include fewer components, additional components, different components, or differently arranged components than illustrated in FIG. 4. For example, user device 210 may include a keyboard, a keypad, and/or other input components. In still other implementations, one or more components of user device 210 may perform one or more tasks described as being performed by one or more other components of user device 210.

FIG. 4 is a diagram of example components of user device 210. As shown in FIG. 4, user device 210 may include a processing unit 400, a memory 410, a user interface 420, a communication interface 430, and/or an antenna assembly 440. Although FIG. 4 shows example components of user device 210, in other implementations, user device 210 may include fewer components, additional components, different components, or differently arranged components than depicted in FIG. 4. In still other implementations, one or more components of user device 210 may perform one or more tasks described as being performed by one or more other components of user device 210.

Processing unit 400 may include a processor, a microprocessor, an application-specific integrated circuit (ASIC), a field-programmable gate array (FPGA), or the like. Processing unit 400 may control operation of user device 210 and its components. In one implementation, processing unit 400 may control operation of components of user device 210 in a manner similar to that described herein. Memory 410 may include a RAM, a ROM, and/or another type of memory to store data and/or instructions that may be used by processing unit 400.

User interface 420 may include mechanisms for inputting information to user device 210 and/or for outputting information from user device 210. Examples of input and output mechanisms might include buttons (e.g., control buttons, keys of keypad, a keyboard, a joystick, etc.); a touch screen interface to permit data and control commands to be input into user device 210 via display 320; a biometric device to receive fingerprint scans, retinal scans, facial signatures, etc.; a speaker (e.g., speaker 310) to receive electrical signals and output audio signals; a microphone (e.g., microphone 330) to receive audio signals and output electrical signals; a display (e.g., display 320) to output visual information (e.g., user interfaces, web pages, etc.); a vibrator to cause user device 210 to vibrate; and/or a camera (e.g., camera 340) to receive video and/or images.

Communication interface 430 may include, for example, a transmitter that may convert baseband signals from processing unit 400 to RF signals and/or a receiver that may convert RF signals to baseband signals. Alternatively, communication interface 430 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications. Communication interface 430 may connect to antenna assembly 440 for transmission and/or reception of the RF signals.

Antenna assembly 440 may include one or more antennas to transmit and/or receive RF signals over the air. Antenna assembly 440 may, for example, receive RF signals from communication interface 430 and transmit them over the air, and receive RF signals over the air and provide them to communication interface 430. In one implementation, for example, communication interface 430 may communicate with a network and/or devices connected to a network (e.g., network 140, etc.).

As described in detail below, user device 210 may perform certain operations described herein in response to processing unit 400 executing software instructions of an application contained in a computer-readable medium, such as memory 410. The software instructions may be read into memory 410 from another computer-readable medium or from another device via communication interface 430. The software instructions contained in memory 410 may cause processing unit 400 to perform processes that will be described later. Alternatively, hardwired circuitry may be used in place of or in combination with software instructions to implement processes described herein. Thus, implementations described herein are not limited to any specific combination of hardware circuitry and software.

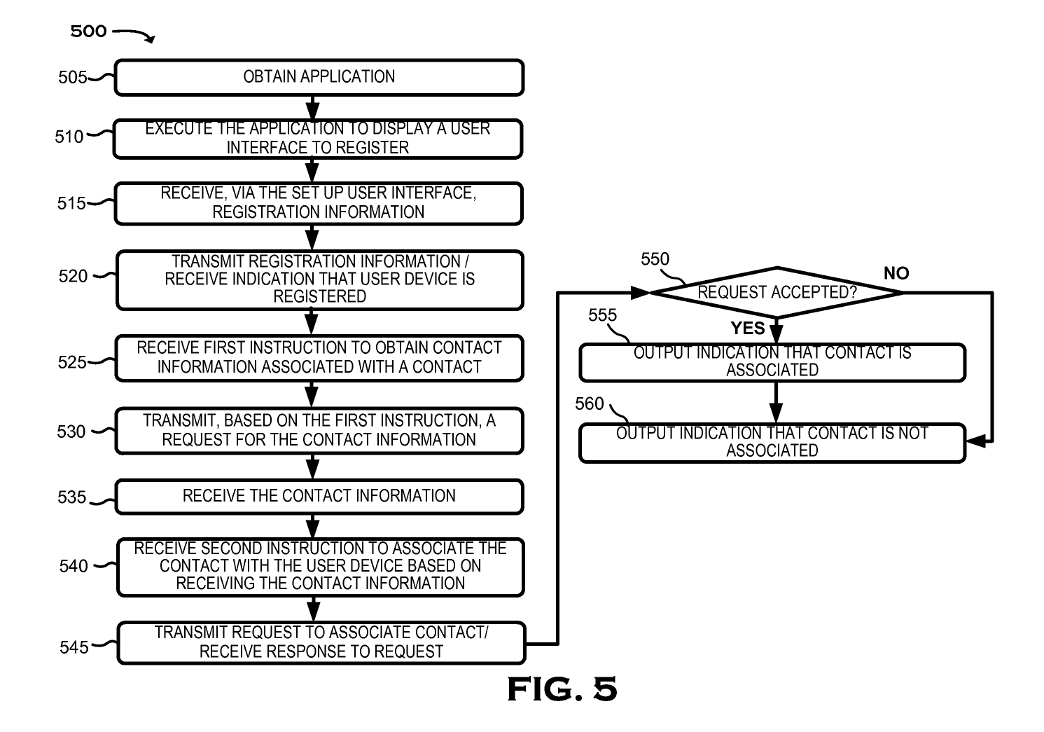

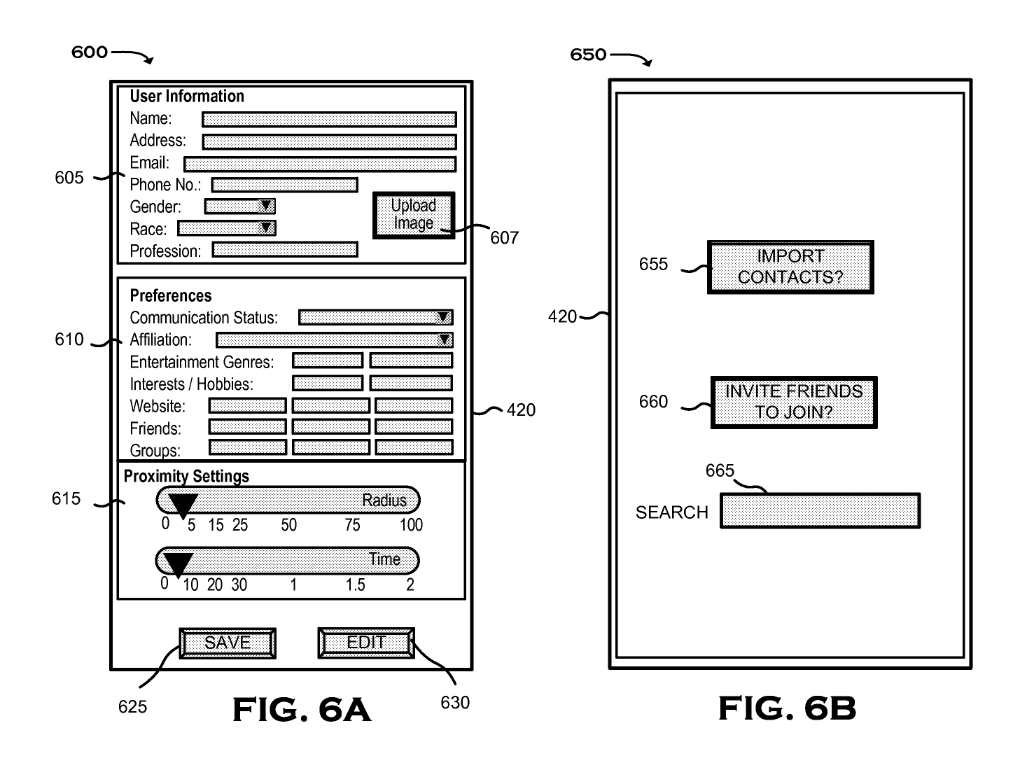

FIG. 5 is a flow chart of an example process 500 to register user device 210 and/or set up a CPRA application according to an implementation described herein. Process 500 may be performed by user device 210 and/or application server 240. Additionally, or alternatively, some or all of process 500 may be performed by a device or a collection of devices separate from, or in combination with, user device 210 and/or application server 240. FIGS. 6A & 6B are diagrams of example user interfaces 600 and 650 for setting up a CPRA application that are capable of being presented on the user device 210. All or a portion of process 500 of FIG. 5 will be described with references to user interfaces 600 and 650 of FIGS. 6A and 6B, respectively.

Process 500 may include obtaining an application (BLOCK 505) and executing the application to display registration user interface (BLOCK 510). For example, a user, associated with user device 210, may instruct user device 210 to access application server 240 (e.g., via a website hosted by application server 240). User device 210 may receive the instruction and may communicate with application server 240 to request that a CPRA application be downloaded to user device 210. Application server 240 may determine a type of user device 210 and may provide a copy of the CPRA application that is supported and/or can be executed by user device 210. User device 210 may receive the CPRA application and may execute the CPRA application to cause a registration user interface (e.g., user interface 600 of FIG. 6A) to be displayed on user device 210.

For example, as illustrated in FIG. 6A, user interface 600 may include a collection of fields and/or buttons, such as a user information field 605, a preferences field 610, a proximity settings field 615, a save button 625, and an edit button 630 that are capable of being displayed on user device 210. User interface 600 may include fields and/or buttons 605-630 for explanatory purposes. In practice, user interface 600 may include additional fields and/or buttons, fewer fields and/or buttons, different fields and/or buttons, and/or differently arranged fields and/or buttons than are described with respect to user interface 600.

User information field 605 may enable a user, of user device 210, to enter information associated with the user (e.g., a name, address, email address, MDN, a gender, an ethnicity of the user, a profession or field of study, etc.). User information field 605 may also, or alternatively, enable the user to upload content, such as an image of the user, a video of the user, etc. (e.g., by selecting upload image button 607). Preferences field 610 may enable the user to enter a communication status (e.g., offline, invisible, visible, super invisible, etc.), an affiliation (e.g., a group membership, school attended, religious organization, club membership, etc.), favorite genres (e.g., favorite movies or movie genres, music or music genres, websites, games, etc.), favorite hobbies and/or interests, a personal and/or favorite websites, information associated with friends of user (e.g., names, email addresses, phone numbers, etc.), information associated with one or more public or private group to which the user is subscribed or desires to be subscribed, etc.

A private group may, for example, be created by user device 210, that identifies other user devices 210 that are invited or permitted to join the private group based on criteria specified by a user of user device 210. Such a private group may generally be closed to the public and/or may be associated with a user preference, a business, and employees of a business, etc. Joining a private group may enable user device 210 to obtain, from application server 240, contact information associated with one or more users, of one or more other user devices 210 that have joined the private group. Obtaining the contact information may permit the user, of user device 210, to determine whether to provide location information, associated with user device 210, to any of the one or more other user devices 210 and/or to specify whether a proximity alert and/or notification is permitted to be received from the one or more user other devices 210. Additionally, or alternatively, joining the private group may cause application server 240 to provide location information, associated with one or more other user devices 210 that are members of the private group, to user device 210 and/or location information, associated with user device 210, to be provided to the one or more of the other user devices 210.

A public group may be created by user device 210, application server 240, content server 265, etc. and may generally be open to the public. Such a public group may, for example, be created in a manner that permits one or more other user devices 210 to join based on criteria specified by an operator of application server 240, content server 265, etc. (e.g., the payment of a fee, membership in some other group, possessing certain credentials, agreeing to follow certain membership rules, etc.). A public group may be associated with, for example, a charitable purpose, a common interest, fundraising, etc. Joining a public group may enable user device 210 to obtain, from application server 240, information associated with one or more users, of user devices 210 that have joined the public group, to permit the user, of user device 210, to determine whether to provide location information to any of the one or more user devices 210 and/or to specify whether a proximity alert and/or notification is permitted to be received from the one or more user devices 210.

Proximity settings field 615 may enable the user to specify a distance at which a proximity alert is to be received when another user device 210, associated with an associated contact (described below) of the user, is within the specified distance relative and/or travel time relative to a location of user device 210. The user may select (e.g., by pressing one or more buttons on a keyboard, a pointing device, by touching a screen, etc.) the desired distance (e.g., shown as Radius in FIG. 6A in feet, miles, meters, kilometers, etc.) and/or travel time (e.g., shown as Time in FIG. 6A in seconds, minutes, hours, a date, etc.) by, for example, sliding one or both sliders (e.g., upside down black triangles) to the desired setting. Save button 625, when selected by the user (e.g., by pressing one or more buttons on a keyboard, a pointing device, by touching a screen, etc.), may cause user device 210 to transmit, as registration information, the information entered into user interface 600 to application server 240. Edit button 630, when selected by the user (e.g., by pressing one or more buttons on a keyboard, a pointing device, by touching a screen, etc.), may enable the user to change or update the registration information.

Returning to FIG. 5, process 500 may also include receiving, via the user interface, registration information (BLOCK 515), and may transmit the registration information and may receive an indication that the user device has been registered (BLOCK 520). For example, the user may enter the registration information into user interface 600 (FIG. 6A) and may select save button 625, which may cause user device 210 to receive the registration information. User device 210 may receive the registration information and may transmit the registration information to application server 240. In one example, user device 210 may store the registration information in a memory associated with user device 210 and/or may transmit the registration information, in a secure manner, to application server 240 using an API associated with the CPRA application and/or using a secure protocol (e.g., a tunneling protocol, HTTPS, SSL, IPsec, and/or some other secure protocol).

Application server 240 may receive the registration information, may register user device 210, and/or may store the registration information in database 245 and/or a memory associated with application server 240. Application server 240 may provide a notification to user device 210 that indicates that user device 210 has been registered. The notification may include confirmation information (e.g., a password, personal identification number, etc.).

Application server 240 by use all or a portion of the registration information to create context information associated with user device 210. For example, application server 240 may determine a communication state (to be described in greater detail below), associated with user device 210, and may associated with communication state with the registration information. Additionally, or alternatively, application server 240 may obtain, from HSS/AAA server 255, information associated with a profile that identifies purchase history, preferences, browsing habits, a subscription level or type, and/or account information associated with user device 210.

As further shown in FIG. 5, process 500 may include receiving a first instruction to obtain contact information associated with a contact (BLOCK 525) and transmit, based on the first instruction, a request for the contact information (BLOCK 530). For example, the CPRA application may cause user device 210 to display a user interface (e.g., user interface 650 of FIG. 6B) that enables information, associated with a contact (hereinafter, “contact information”) that is selected by the user, to be obtained. The contact may, for example, correspond to another user, of a different user device 210, with which the user interacts via a social networking service or application, messaging (e.g., email, instant messaging, etc.), telephone calls, etc.

For example, as illustrated in FIG. 6B, user interface 650 may include a collection of buttons and/or fields, such as an import contacts button 655, a invite friends to join button 660 (hereinafter “invite friends button 660”), and/or a search field 665 that are capable of being displayed on user device 210. User interface 650 may include fields and/or buttons 655-665 for explanatory purposes. In practice, user interface 650 may include additional fields and/or buttons, fewer fields and/or buttons, different fields and/or buttons, and/or differently arranged fields and/or buttons than are described with respect to user interface 650.

Import contacts button 655 may, when selected by the user, cause user device 210 to obtain contact information, associated with one or more contacts of the user, from a source that is specified by the user, such as, for example, a memory associated with user device 210 (e.g., an electronic phone book used by user device 210 to make calls) and/or an application or service (e.g., a social networking, a messaging, etc. application and/or service) accessed by user device 210. Invite friends button 660, when selected by the user, may enable the user to select (e.g., by pressing one or more buttons on a keyboard, a pointing device, by touching a screen, etc.) a contact to send a request to download a CPRA application to a different user device 210 with which the selected contact is associated. Search field 665 may enable the user to search for a contact, or some other user, that has downloaded the CPRA application based on a search query (e.g., a name, MDN, etc.) entered into search field 665.

Returning to FIG. 5, the user may provide a first instruction to user device 210 (e.g., by selecting import contacts button 655 of FIG. 6B) to obtain contact information, associated with a contact, which may cause user device 210 to prompt the user to specify from which source the contact information is to be obtained (e.g., a social networking service, a messaging application, an electronic phone book application, etc.). For example, the user may indicate that contact information, stored on user device 210, is to be obtained, which may cause user device 210 to obtain the contact information from a memory associated with user device 210. The contact information may include an identifier of the contact (e.g., a name, an image, video content, etc.), an address (e.g., an email address, an Internet Protocol (IP) address, etc.), information associated with the different user device 210 with which the contact is associated (e.g., a MDN, an electronic serial number (ESN), media access control (MAC) address, a subscriber identity module (SIM) uniform resource identifier (URI), an international mobile subscriber identify (IMSI), etc.). Additionally, or alternatively, the user may indicate that the contact information is to be obtained from a social networking application or service (e.g., or some other application or service) that is used by the user that may cause user device 210 to communicate with application server 240 to obtain the contact information. Such a communication may include a username, password and/or other access credentials that enables user device 210 and/or the user to access the social networking application and/or service. Application server 240 may receive the request and may communicate with content server 265 (e.g., that provides, hosts a website, and/or otherwise allows the social networking application and/or service to be accessed using the access credentials) to obtain the contact information. Application server 240 may transmit the contact information to user device 210.

As also shown in FIG. 5, process 500 may include receiving the contact information (BLOCK 535) and receiving a second instruction to associate the contact with the user device based on receiving the contact information (BLOCK 540). For example, user device 210 may receive the contact information and may store the contact information in a manner that can be accessed by the CPRA application. Additionally, or alternatively, the user may provide a second instruction to user device 210 (e.g., when the user selects invite friends button 660 of FIG. 6B) to associate the contact with user device 210. The user may also, or alternatively, perform a search of a different contact (e.g., by entering contact information such as a name, address, username, etc. into search field 665 of FIG. 6B) to determine whether the different contact has downloaded a copy of the CPRA application to a particular user device 210 with which the different contact is associated.

As further shown in FIG. 5, process 500 may include transmitting a request to associate the contact and to receive a response to the request (BLOCK 545). For example, user device 210 may use the contact information to transmit a request, to the different user device 210 with which the contact is associated, to obtain a CPRA application. The request may include a notification that includes an address (e.g., an IP address, URL, link, etc.) associated with application server 240 from which a copy of the CPRA application can be obtained. Application server 240 may provide an indication to user device 210 indicating whether or not the request was accepted (e.g., when application server 240 receives a request, from different user device 210, to download the CPRA application) or not accepted (e.g., if application server 240 does not receive the request to download the CPRA application).

As yet further shown in FIG. 5, if the request is accepted (BLOCK 550—YES), then process 500 may include outputting an indication that the contact is associated (BLOCK 555). For example, the contact may cause different user device 210 to communicate with application server 240 to download a copy of the CPRA application. Application server 240 may receive the request and may provide a copy of the CPRA application to different user device 210. Application server 240 may also, or alternatively, provide a notification, to user device 210, that indicates that the request, to download the CPRA application, was accepted. User device 210 may receive the notification that the request was accepted and may display and indication that the contact is associated.

As also shown in FIG. 5, if the request is not accepted (BLOCK 550—NO), then process 500 may include outputting an indication that the contact is not associated (BLOCK 560). For example, application server 240 may not receive the request to download a copy of the CPRA application to different user device 210. Application server 240 may, based on not receiving the request, provide a notification, to user device 210, that indicates that the request, to download the CPRA application, was not accepted. User device 210 may receive the notification that the request was not accepted and may display and indication that the contact is not associated.

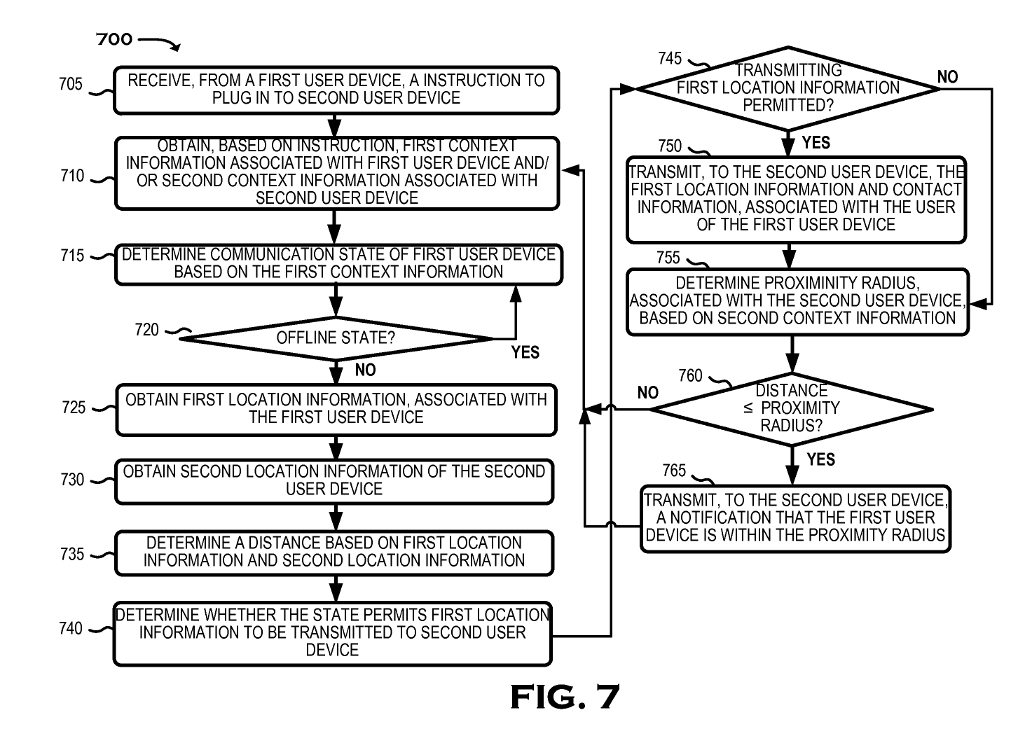

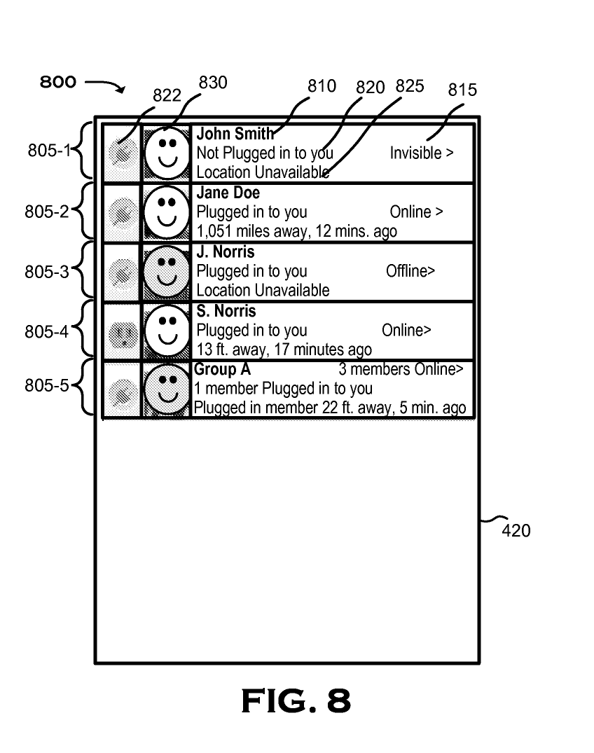

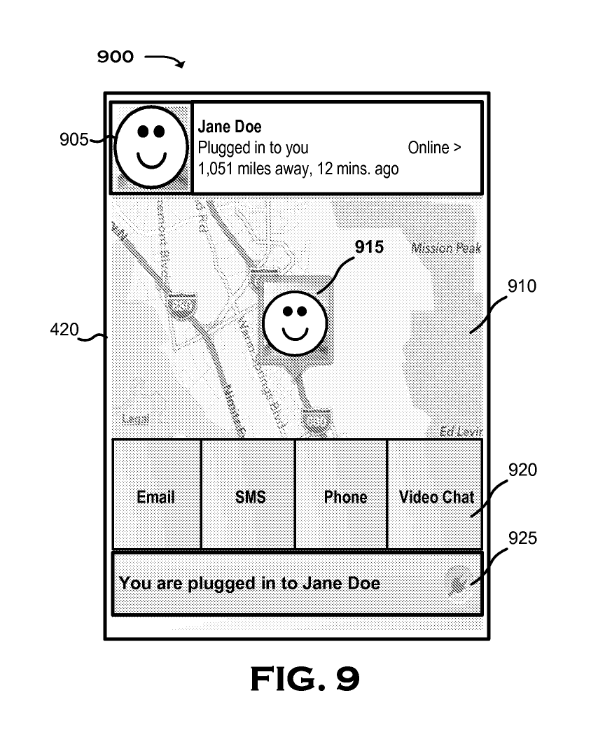

FIG. 7 is a flow chart of an example process 700 to set a communication state of user device 210 to enable location information to be transmitted to another user device 210 according to an implementation described herein. Process 700 may be performed by application server 240 and/or user device 210. Additionally, or alternatively, some or all of process 700 may be performed by a device or a collection of devices separate from, or in combination with, application server 240 and/or user device 210. FIG. 8 is a diagram of an example user interface 800 that identifies a list of contacts associated with user device 210. FIG. 9 is a diagram of an example user interface 900 that identifies a location and/or a communication state of a selected contact associated with user device 210. All or a portion of process 700 of FIG. 7 will be described with references to user interfaces 800 and 900 of FIGS. 8 and 9, respectively.

As shown in FIG. 7, process 700 may include receiving, from a first user device, an instruction to plug in to a second user device (BLOCK 705) and obtaining, based on the instruction, first context information associated with the first user device and second context information associated with the second user device (BLOCK 710). For example, application server 240 may receive, from first user device 210, a request to plug in to second user device 210. First user device 210 may transmit the request, to application server 240, when a user of first user device 210, using the CPRA application, requests that a list of associated contacts (e.g., associated in a manner similar to that described above with respect to blocks 540-555 of FIG. 5) be displayed on first user device 210, and selects a contact, associated with a second user device 210, from the list of associated contacts. The list of contacts may, for example, correspond to that which is illustrated in user interface 800 of FIG. 8.

For example, as illustrated in FIG. 8, user interface 800 may include a collection of fields and/or objects such as a group of contact fields 805-1, . . . , 805-5 (hereinafter collectively referred to as “contact fields 805” and individually, as a “contact field 805”), a name field 810, a communication state field 815 (hereinafter, “state field 815”), a receive plug status field 820, a transmit plug status object 822, a distance field 825, and an image field 830. User interface 800 may include fields and/or objects 805-830 for explanatory purposes. In practice, user interface 800 may include additional fields and/or objects, fewer fields and/or objects, different fields and/or objects, and/or differently arranged fields and/or objects than are described with respect to user interface 800.

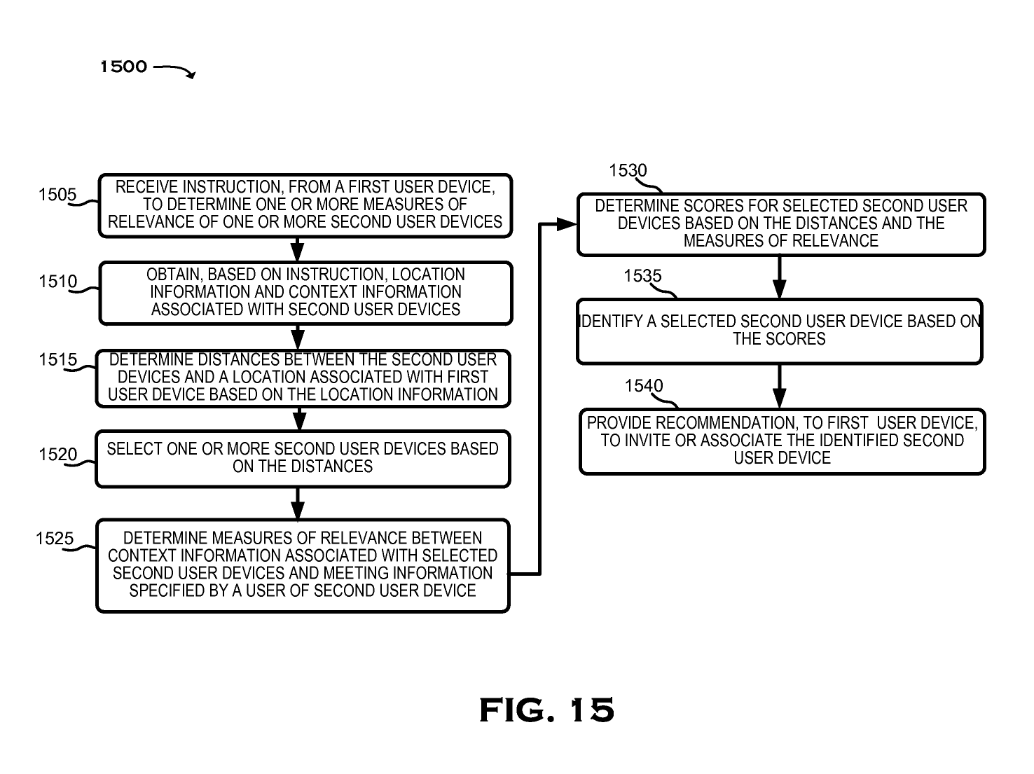

Contact field 805 may identify all or a portion of contact information associated with a particular contact of a user of first user device 210 that was associated with first user device 210 in a manner similar to that described above (e.g., with respect to process 500 of FIG. 5). Additionally, or alternatively, contact field 805 may be associated with a group (e.g., a public and/or private group) of which one or more second user devices 210 are members. The user may select (e.g., by pressing one or more buttons on a keyboard, a pointing device, by touching a screen, etc.) the group contact, which may have the effect of selecting one, some, or all of second user devices 210 that are members of the group. Additionally, or alternatively, contact field 805 may correspond to a contact that application server 240 has recommended to first user device 210 based on a measure of relevance between context information associated with the contact associated with a second user device 210 and context information associated with first user device 210. The measure of relevance may be determined, by application server 240, in a manner to be described in greater detail below (e.g., with respect to FIG. 15).

Name field 810 may identify a name, identifier and/or other information that uniquely identifies the particular contact. State field 815 may identify a communication state (e.g., offline, invisible, visible, fully visible, etc.) of a particular user device 210 with which the particular contact is associated. Receive plug status field 820 may identify whether the particular user device 210 is plugged in to, or unplugged from, first user device 210. Transmit plug status object 822 may indicate whether first user device 210 is plugged into the particular user device 210. For example, when first user device 210 is plugged into the particular user device 210, transmit plug status object 822 may correspond to a first appearance, such as a first icon, color, shape, logo, symbol, etc. (e.g., as shown by the male plug icon in FIG. 8). When first user device 210 is unplugged from the particular user device 210, transmit plug status object 822 may correspond to a second appearance that is different from the first appearance, such as a second, different icon, color, shape, logo, symbol, etc. (e.g., as shown by the female plug icon in FIG. 8). Distance field 825 may identify whether location information, associated with the particular user device 210, is available to first user device 210 (e.g., based on state field 815 and/or receive plug status field 820). For example, in the event that state field 815 indicates that the particular user device 210 is in an online and/or visible communication state, location information may be available to first user device 210 if particular user device 210 is plugged into first user device 210. If, however, state field 815 indicates that the particular user device 210 is in an offline and/or invisible communication state, location information may not be available to first user device 210 regardless of whether the particular user device 210 is plugged in to or unplugged from first user device 210. Image field 830 may include an image (e.g., a thumbnail image, etc.) of the associated contact.

Other contact fields 805 (e.g., 805-2-805-5) may be included in the list of contacts and each field may include respective contact information based on the identity of the associated contact, the communications state of a respective user device 210 with which the associated contact is associated, whether the respective user device 210 is plugged in to, or unplugged from, first user device 210, whether first user device 210 is plugged in to, or unplugged from, the respective user device 210, and/or a respective distance between first user device 210 and the respective user device 210 when the communication state of the respective user device 210 permits location information to be provided to first user device 210. Contact field 805-5 may correspond to a group (e.g., Group A), that identifies a communication state of one or more member user devices 210 associated with the group; whether a member user device 210 is plugged in to, or unplugged from, first user device 210; a location of one or more member user devices 210; and/or whether the user, of first user device 210, is plugged in to the group.

Returning to FIG. 7, the user, of first user device 210, may select the contact, associated with second user device 210 (e.g., by pressing one or more buttons on a keyboard, a pointing device, by touching a screen, etc.), to plug in to by selecting transmit plug state object 822 associated with the contact. Selecting transmit plug state object 822 may cause transmit plug state object 822 to change from a second appearance (e.g., associated with the female plug icon) to the first appearance (e.g., associated with the male plug icon). Additionally, or alternatively, first user device 210 may receive the selection of the transmit plug object 822 and may transmit, to application server 240, the instruction to plug into the second user device 210.

Application server 240 may receive the instruction and may obtain, from database 245, first context information associated with first user device 210 and/or second context information, associated with second user device 210. Additionally, or alternatively, application server 240 may communicate with first user device 210 and/or second user device 210 to obtain all or a portion of the first context information and/or second context information, respectively (e.g., to obtain the latest, most up-to-date communication state, proximity setting, etc.).

As also shown in FIG. 7, process 700 may include determining a communication state of first user device 210 based on the first context information (BLOCK 715). For example, application server 240 may obtain, from the first context information, information that identifies the communication state of first user device 210 (e.g., offline, invisible, visible, fully visible, etc.). Additionally, or alternatively, application server 240 may update first context information by indicating that first user device 210 is plugged in to second user device 210. Application server 240 may also, or alternatively, store the updated first context information in database 245.

As further shown in FIG. 7, if the communication state is in the offline state (BLOCK 720—YES), process 700 may include determining the communication state of the first user device based on the first context information (BLOCK 715). For example, if the communication state indicates that first user device 210 is in an offline state, application server 240 may not obtain first location information associated with first user device 210. Additionally, or alternatively, application server 240 may also, or alternatively, continue to obtain first context information (e.g., from database 245 and/or directly from first user device 210) determine whether the user, of first user device 210, changes the offline state to an online state.

As yet further shown in FIG. 7, if the communication state is not in the offline state (BLOCK 720—NO), process 700 may include obtaining first location information associated with the first user device (BLOCK 725) and obtaining second location information associated with the second user device (BLOCK 730). For example, if the communication state indicates that first user device 210 is in a communication state other than the offline state (e.g., an invisible state, a visible state, a fully visible state, etc.), application server 240 may communicate with first user device 210 and/or base station 220, via which first user device 210 is communicating, to obtain first location information associated with first user device 210. Additionally, or alternatively, application server 240 may communicate with second user device 210 and/or another base station 220, via which second user device 210 is communicating, to obtain second location information associated with the second user device 210.

As also shown in FIG. 7, process 700 may include determining a distance based on the first location information and the second location information (BLOCK 735) and identifying whether the state permits the first location information to be transmitted to the second user device (BLOCK 740). For example, application server 240 may identify a first location, at which the first user device 210 is located, based on the first location information and a second location, at which the second user device 210 is located, based on the second location information. Additionally, or alternatively, application server 240 may determine a distance between first user device 210 and second user device 210 based on a distance between the first location and the second location (e.g., based on a Euclidean distance in two dimensions, three dimensions, etc. or other known methods of determining distance). Application server 240 may also, or alternatively, determine whether the communication state permits the first location information to be provided to second user device 210.

Additionally, or alternatively, application server 240 may determine an estimated period of time (hereinafter, “travel time”) for first user device 210 to travel to second user device 210 based on the distance. The estimated travel time may be based on posted speed limits on routes that are likely to be used by first user device 210, traffic patterns and congestion, etc.

As further shown in FIG. 7, if transmitting the first location information is permitted (BLOCK 745—YES), process 700 may include transmitting, to the second user device, the first location information and/or contact information associated with the user of the first user device (BLOCK 750). For example, application server 240 may determine, based on the first context information, that the communication state corresponds to a visible or fully visible state. The visible state may indicate that the user authorizes the first location information, to be transmitted to any user device 210 to which the user desires to plug in to. The fully visible state may indicate that the user authorizes the first location information, to be transmitted to any user device 210 with which an associated contact is associated.

Based on the determination that first user device 210 is in the visible or fully visible communication state, application server 240 may provide the first location information to second user device 210. Additionally, or alternatively, application server 240 may provide information, associated with the user, to second user device 210 to enable the CRPA application, being executed by second user device 210, to display a user interface that includes a map on which first user device 210 is identified and/or the contact information, associated with the user of first user device 210. Such a user interface may enable a user, of second user device 210, to monitor a location and/or communication state of first user device 210 and/or to communicate with first user device 210.

Additionally, or alternatively, second user device 210 may plug in to first user device 210 which may cause application server 240, in a manner similar to that described above, to provide location information, associated with the second user device 210, to first user device 210. First user device 210 may receive the location information and may display the location information on first user device via a user interface (e.g., user interface 900 of FIG. 9).

For example, as shown in FIG. 9, user interface 900 may include a collection of fields and/or buttons, such as contact field 905, map field 910, contact window 915, communication buttons 920, and transmit plug state 925. User interface 900 may include fields and/or objects 905-925 for explanatory purposes. In practice, user interface 900 may include additional fields, windows, and/or buttons, fewer fields, windows, and/or buttons, different fields, windows, and/or buttons, and/or differently arranged fields, windows, and/or buttons than are described with respect to user interface 900.

Contact field 905 may correspond to contact field 805 of FIG. 8. Thus, in the example above, contact field 905 may include contact information, associated with the user of a particular user device 210. Map field 910 may include geographical information associated with a location or geographical area in which the particular user device 210, with which the contact identified in contact field 905, is located. Thus, in the example above, map field 910 may include geographical information associated with a location of second user device 210. Contact window 915 may include an image or other information, associated with the contact identified in contact field 905, that is located in map field 910 at a location that corresponds to a location of the particular user device 210 that has plugged into user device 210. Thus, in the example above, contact window 915 may include an image or other information, associated with the user of second user device 210, at a location within map field 910 that corresponds to the location of second user device 210. Buttons 920 may include a button that, when selected by a user of the particular user device 210, enables the user to send an email message, send an instant message (e.g., based on a text message protocol, a short message service (SMS) protocol, etc.), place a call or place a video call to the contact identified in contact field 905. Thus, in the example above, buttons 920 may permit the user, of first user device 210, to send an email, instant message, place a call, or place a video call to the user of second user device 210. Transmit plug state 925 may corresponds to transmit plug state 822 of FIG. 8. Thus, in the example above, transmit plug state 925 may identify whether the user, of first user device 210, is plugged into second user device 210.

As yet further shown in FIG. 7, if transmitting the first location information is not permitted (BLOCK 745—NO) or after transmitting the first location information (BLOCK 750), process 700 may include determining a proximity radius, associated with the second user device, based on the second context information (BLOCK 755). For example, application server 240 may determine, based on the first context information, that the communication state corresponds to an invisible state. The invisible state may indicate that the user does not authorize the first location information to be transmitted to any user device 210 regardless of whether the user has plugged in to any user device 210. Based on the determination that the user does not authorize the transmission of the first location information, application server 240 may not transmit the first location information and/or contact information to second user device 210. Additionally, or alternatively, application server 240 may obtain, from the second context information, information that identifies a proximity radius associated with second user device 210.

In the case when the communication state permits transmitting the first location information to second user device 210 and after transmitting the first location information, to second user device 210, application server 240 may obtain, from the second context information, information that identifies a user-specified proximity radius and/or proximity travel time associated with second user device 210. The proximity travel time may correspond to a time period for another user device 210 to travel to second user device 210.

As also shown in FIG. 7, if the distance is not less than or equal to the proximity radius (BLOCK 760—NO), process 700 may include obtaining first context information associated with the first user device (BLOCK 710). For example, application server 240 may determine that the distance is not less than or equal to the proximity radius obtained from the second context information. Based on the determination that the distance is not less than or equal to the proximity radius, application server 240 may not transmit a notification (e.g., a proximity alert) that first user device 210 is within the proximity radius. Additionally, or alternatively, application server 240 may determine that the estimated travel time is not less than or equal to the proximity travel time obtained from the second context information. Based on the determination that the estimated travel time is not less than or equal to the proximity travel time, application server 240 may not transmit a notification (e.g., a proximity alert) that first user device 210 is within the proximity travel time. Application server 240 may also, or alternatively, obtain updated first context information to determine whether the communication state, of first user device 210, has changed.

As further shown in FIG. 7, if the distance is less than or equal to the proximity radius (BLOCK 760—YES), process 700 may include transmitting, to the second user device, a notification that the first user device is within the proximity radius (BLOCK 765). Application server 240 may determine that the distance is less than or equal to the proximity radius obtained from the second context information and may transmit, to second user device 210, a notification (e.g., a proximity alert) that first user device 210 is within the proximity radius. Additionally, or alternatively, application server 240 may determine that the estimated travel time is less than or equal to the proximity travel time obtained from the second context information and may transmit, to second user device 210, a notification (e.g., a proximity alert) that first user device 210 is within the proximity travel time. Application server 240 may also, or alternatively, obtain updated first context information to determine whether the communication state, of first user device 210, has changed.

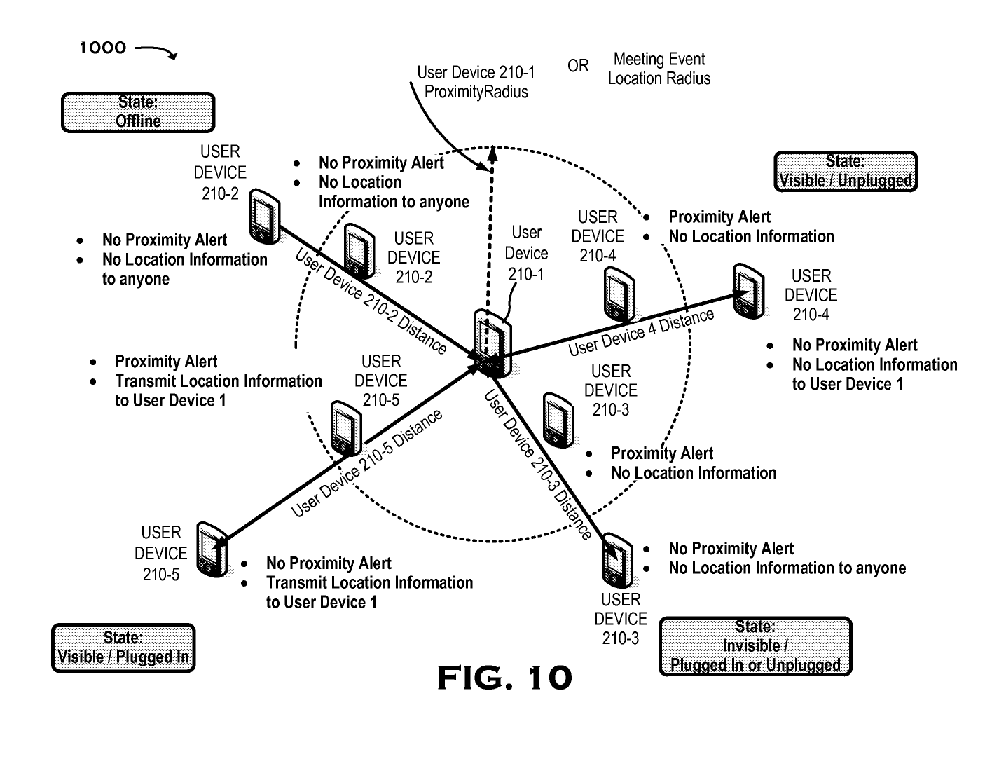

FIG. 10 is a diagram of user devices in various user-defined communications states 1000 (hereinafter, “communication state 1000”) that may be used to control the manner in which location information, associated with user device 210, is transmitted. Communication states 1000 may identify a group of user devices 210-1, . . . , 210-5. A user of user device 210-1 may desire to receive a proximity alert when another user device 210, associated with a contact, is nearby and may a proximity radius (e.g., shown as the dashed, upward pointing arrow in FIG. 10) that establishes a perimeter (e.g., shown as the dashed circle in FIG. 10) at which a proximity alert is to be received. User device 210-1 may be located approximately at the center of the perimeter.

Whether a proximity alert is sent may, in a manner similar to that described above with respect to process 700 of FIG. 7) depend on a distance between (and/or travel time) user device 210-1 and another user device 210 relative to the proximity radius and/or on a communication state of the other user device 210. Additionally, or alternatively, whether location information, associated with the other user device 210 is provided to user device 210-1 may depend on a communication state of the other user device 210 and/or whether the other user device 210 has plugged in to user device 210-1 as described above with respect to FIG. 7.

For example, user device 210-2 may be set to an offline state. The offline state may preclude application server 240 from obtaining any location information associated with user device 210-2. Thus, application server 240 may not provide location information associated with user device 210-2 or proximity alerts to user device 210-1 regardless of whether user device 210-2 is located outside or inside the proximity radius.

User device 210-3 may be set to an online, but invisible state. The invisible state may cause application server 240 to obtain location information associated with user device 210-3, but may preclude application server 240 from providing the location information to user device 210-1 regardless of whether user device 210-3 is plugged in to, or unplugged from, user device 210-1. When user device 210-3 is not located within the proximity radius, application server 240 may not provide a proximity alert to user device 210-1. However, when user device 210-3 moves to a location within the proximity radius, application server 240 may provide a proximity alert to user device 210-1 that indicates that user device 210-3 is within the proximity radius, but the location of user device 210-3, within the proximity radius, may not be provided.

User device 210-4 may be set to an online, but visible state. The visible state may cause application server 240 to obtain location information associated with user device 210-3 and may enable application server 240 to provide the location information to user device 210-1, provided that user device 210-3 is plugged in to user device 210-1. In this example, user device 210-4 is not being plugged in to user device 210-1, which may preclude application server 240 from providing the location information to user device 210-1. Application server 240 may provide proximity alerts to user device 210-1 in a manner similar to that described regarding user device 210-3.

User device 210-5 may be set to an online and visible state, and may be plugged in to user device 210-1. The visible state and being plugged in to user device 210-1 may permit application server 240 to provide the location information to user device 210-1. Application server 240 may provide proximity alerts, to user device 210-1, in a manner similar to that described regarding user device 210-3.

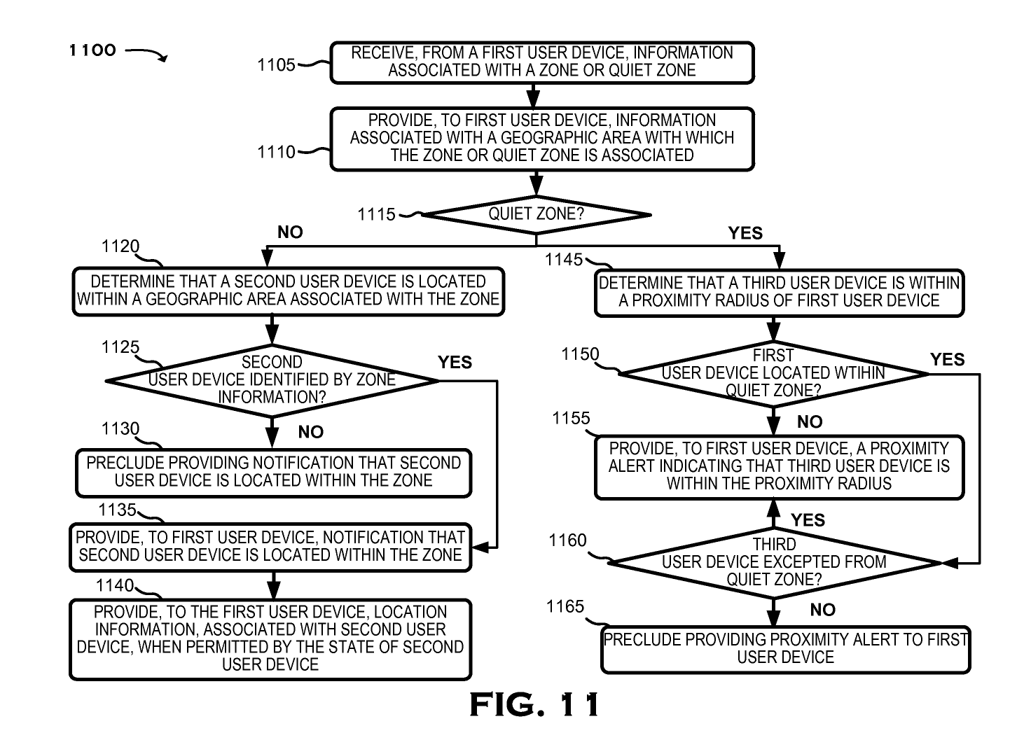

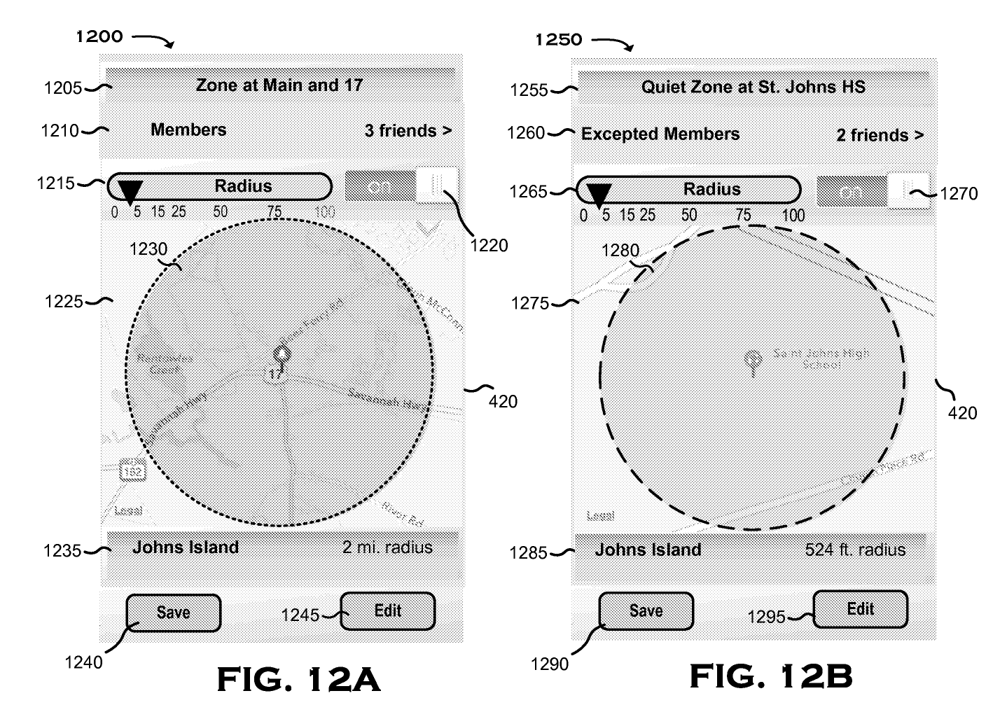

FIG. 11 is a flowchart of an example process 1100 to create, track, and/or manage a geographical zone with which to monitor, manage or preclude the relative proximity of user device 210 according to an implementation described herein. Process 1100 may be performed by application server 240 and/or user device 210. Additionally, or alternatively, some or all of process 1100 may be performed by a device or a collection of devices separate from, or in combination with, application server 240 and/or user device 210. FIGS. 12A and 12B are example user interfaces 1200 and 1250 that can be used to create, track, or manage a zone and/or quiet zone created by user device 210. All or a portion of process 1100 of FIG. 11 will be described with references to user interfaces 1200 and 1250 of FIGS. 12A and 12B, respectively.

As shown in FIG. 11, process 1100 may include receiving, from a first user device, information associated with a zone or a quiet zone (BLOCK 1105) and providing, to the first user device, information, associated with a geographical area with which the zone or the quiet zone are associated (BLOCK 1110). For example, a user, of first user device 210, may desire to set up a zone or a quiet zone to manage and control a manner in which proximity alerts and/or notifications, associated with another user device 210, are received by first user device 210. For example, the user may desire to create a zone associated with a geographic area (e.g., associated with a locality of a school, a place of employment, an address to which goods or services are to be delivered, etc.) to track and/or monitor whether a selected user device 210 (and/or one or more user devices 210 associated with a selected public or private group), with which a particular contact is associated (e.g., a son, daughter, spouse, members of a group, etc.), is entering or exiting the zone. Additionally, or alternatively, the user may desire to create a quiet zone, associated with a geographical area, that precludes first user device 210 from receiving proximity alerts from any other user device 210, except a particular user-selected user device 210 (sometimes referred to as “excepted user device 210”), when first user device 210 is located within the quiet zone and when any of the other user devices 210 are within the proximity radius of first user device 210.

The user may instruct first user device 210 to create a zone, which may cause the CPRA application to present a user interface (e.g., user interface 1200 of FIG. 12A) on first user device 210. For example, as illustrated in FIG. 12A, user interface 1200 may include a collection of fields and buttons such as zone location field 1205, members field 1210, zone proximity radius field 1215, zone on/off button 1220, map field 1225, zone perimeter field 1230, zone status field 1235, save button 1240 and edit button 1245. User interface 1200 may include fields and/or buttons 1205-1245 for explanatory purposes. In practice, user interface 1200 may include additional fields and/or buttons, fewer fields and/or buttons, different fields and/or buttons, and/or differently arranged fields and/or buttons than are described with respect to user interface 1200.

Zone location field 1205 may enable a user to enter information that identifies the zone or a location (e.g., address, map coordinates, latitude and/or longitude, etc.) at which the zone is to be located. Members field 1210 may, when selected by the user, enable the user to select a contact (e.g., associated with a different user device 210), from a list of contacts (e.g., by pressing one or more buttons on a keyboard, a pointing device, by touching a screen, etc.), to be associated with the zone. Zone proximity radius field 1215 may permit the user to set a radius or dimension of the zone based on the location entered into zone location field 1205. Zone on/off button 1220 may permit the user to turn on or turn off the zone. Map field 1225 may include information associated with a geographical area in which the zone is to be created. Zone perimeter field 1230 may correspond to the zone proximity radius set by the user via zone proximity radius field 1215. Zone status field 1235 may identify a general geographical area and/or radius associated with the zone. Save button 1240 may, when selected by the user, enable zone information, entered into user interface 1200, to be received by user device 1210 and/or transmitted to application server 240. Edit button 1245, when selected by the user, may enable the user to change the zone information.

Returning to FIG. 11, the user may enter zone information into user interface 1200 and, in so doing, may select, from a list of associated contacts, a contact, associated with a different user device 210, to be associated with the zone. First user device 210 may receive the zone information and may transmit the zone information to application server 240.

Additionally, or alternatively, the user may instruct first user device 210 to create a quiet zone, which may cause the CPRA application to present a different user interface (e.g., user interface 1250 of FIG. 12B) on first user device 210. For example, as illustrated in FIG. 12B, user interface 1250 may include a collection of fields and/or buttons, such as quiet zone location field 1255, excepted members field 1260, quiet zone proximity radius field 1265, quiet zone on/off button 1270, map field 1275, quiet zone perimeter field 1280, zone status field 1285, save button 1290 and edit button 1295. User interface 1250 may include fields and/or buttons 1255-1295 for explanatory purposes. In practice, user interface 1250 may include additional fields and/or buttons, fewer fields and/or buttons, different fields and/or buttons, and/or differently arranged fields and/or buttons than are described with respect to user interface 1250.

Quiet zone location field 1255 may enable the user to enter information that identifies the quiet zone or a location (e.g., address, map coordinates, latitude and/or longitude, etc.) at which the quiet zone is to be located. Excepted members field 1260 may, when selected by the user, enable the user to select a contact (e.g., associated with a particular user device 210), from a list of contacts (e.g., by pressing one or more buttons on a keyboard, a pointing device, by touching a screen, etc.), to be excepted and/or exempted from the quiet zone (e.g., to permit proximity alerts to be received when the particular user device 210 enters the quiet zone). Quiet zone proximity radius field 1265 may permit the user to set a radius or dimension of the quiet zone based on the location entered into quiet zone location field 1255. Quiet zone on/off button 1270 may permit the user to turn on or turn off the quiet zone. Map field 1275 may include information associated with a geographical area in which the quiet zone is to be created. Quiet zone perimeter field 1280 may correspond to the quiet zone proximity radius set by the user via quiet zone proximity radius field 1265. Quiet zone status field 1235 may identify a general geographical area and/or radius associated with the quiet zone. Save button 1290 may, when selected by the user, enable quiet zone information, entered into user interface 1250, to be received by user device 1210 and/or transmitted to application server 240. Edit button 1295, when selected by the user, may enable the user to change the quiet zone information.

Returning to FIG. 11, the user may enter quiet zone information into user interface 1250 and, in so doing, may select, from a list of associated contacts, a particular contact, associated with a particular user device 210, to be excepted and/or exempted from the quiet zone. First user device 210 may receive the quiet zone information and may transmit the quiet zone information to application server 240. Application server 240 may receive the information associated with the zone and/or the quiet zone.

Application server 240 may, based on the received information, identify a location at which a zone or quiet zone is to be created (e.g., based on zone location field 1205 of FIG. 12A and/or quiet zone location field 1255 of FIG. 12B). Application server 240 may communicate with content server 265 to obtain geographical information associated with a geographical area in which the identified location is located and may provide, to first user device 210, the geographical information. First user device 210 may receive the geographical information and may display the geographical information on first user device 210 (e.g., via map field 1225 of FIG. 12A or map field 1275 of FIG. 12B).

As also shown in FIG. 11, if the received information is not associated with a quiet zone (BLOCK 1115—NO), process 1100 may include determining that a second user device is located within the geographical area associated with the zone (BLOCK 1120). For example, application server 240 may determine that the information, received from first user device 210, corresponds to information associated with a zone and may perform an operation to create a zone. For example, application server 240 may store the information associated with a zone in database 245 and/or may update context information, associated with first user device 210, by associating the information associated with the zone with the context information. Additionally, or alternatively, application server 240 may identify a location of the zone (e.g., from zone location field 1205 of FIG. 12A), and/or a size and/or perimeter of the zone (e.g., zone proximity radius 1215 of FIG. 12A) based on the information associated with the zone.

Additionally, or alternatively, application server 240 may determine whether any user device 210 is located within the zone based on the location and/or the proximity radius of the zone. Application server 240 may, for example, obtain and/or examine location information, associated with user devices 210 that are known to be located within a geographical area in which the zone is located and may identify a second user device 210, of the user devices 210 located in the geographical area, that is located within the proximity radius of the zone. Application server 240 may obtain the location information from database 245 and/or may communicate with each of the user devices 210 to obtain updated location information.

As further shown in FIG. 11, if the second user device is not identified by the zone information (BLOCK 1125—NO), process 1100 may preclude providing a notification that the second user device is located within the zone (BLOCK 1130). For example, application server 240 may obtain context information, associated with second user device 210, to obtain information associated with second user device 210 (e.g., an MDN, an IP address, a MAC address, an ESN, a SIM URI, an IMSI etc.) and/or information associated with a user of second user device 210 (e.g., a name, address, username, etc.). Application server 240 may determine whether the information associated with second user device 210 and/or the information associated with the user matches information associated with the selected user device 210 and/or information associated with the selected contact, respectively, obtained from the information associated with the zone. In the event that application server 240 determines that the information associated with second user device 210 and/or the information associated with the user does not match the information associated with the selected user device 210 and/or the information associated with the selected contact, respectively, application server may not provide a notification that second user device 210 is located within the zone.

As yet further shown in FIG. 11, if the second user device is identified by the zone information (BLOCK 1125—YES), process 1100 may include providing, to the first user device, a notification that the second user device is located within the zone (BLOCK 1135). For example, in the event that application server 240 determines that the information associated with second user device 210 and/or the information, associated with the user, does not match the information associated with the selected user device 210 and/or the information associated with the selected contact, respectively, application server 240 may provide, to first user device 210, a notification that second user device 210 is located within the zone. The notification may include the information, associated with second user device 210 and/or the information associated with the user.

As also shown in FIG. 11, process 1100 may include providing the first user device, location information, associated with the second user device, when permitted by a state of the second user device (BLOCK 1140). For example, application server 240 may determine, based on the context information, associated with second user device 210, a communication state of second user device 210. Application server 240 may, in a manner similar to that described above (e.g., with respect to blocks 715-750 of FIG. 7), provide location information, associated with second user device 210, to first user device 210 if the communication state permits the location information to be provided (e.g., when the communication state corresponds to a visible state and plugged in to first user device 210, or fully visible state). However, if the communication state does not permit the location information to be provided to first user device 210, application server 240 may not provide the location information to first user device 210 (e.g., when the communication state corresponds to an offline state, an invisible state, or a visible state and unplugged from first user device 210).

As shown in FIG. 11, if the received information is associated with a quiet zone (BLOCK 1115—YES), process 1100 may include determining that a third user device is located within a proximity radius of the first user device (BLOCK 1145). For example, application server 240 may determine that the information, received from first user device 210, corresponds to information associated with a quiet zone and may perform an operation to create a quiet zone. For example, application server 240 may store the information associated with the quiet zone in database 245 and/or may update context information, associated with first user device 210, by associating the information associated with the quiet zone with the context information. Application server 240 may also, or alternatively, identify a location of the quiet zone within the geographical area and/or identify a size and/or perimeter of the quiet zone based on the information associated with the quiet zone (e.g., quiet zone proximity radius 1265 of FIG. 12B).

Additionally, or alternatively, application server 240 may determine whether any user device 210 is located within the proximity radius of first user device 210. Application server 240 may, for example, communicate with first user device 210 and/or base station 220, via which first user device 210 is communicating, to determine a location of first user device 210. Application server 240 may also, or alternatively, communicate with database 245 to obtain context information, associated with first user device 210, to identify a proximity radius set by a user of first application server 240. Application server 240 may also, or alternatively, obtain and/or examine location information, associated with user devices 210 that are known to be located within a geographical area in which the first user device 210 is located and/or may identify a third user device 210, of the user devices 210 within the geographical area, that is located within the proximity radius of first user device 210 based on location information associated with third user device 210. Application server 240 may communicate with each of the user devices 210 and/or base stations 220, via which the user devices 210 are communicating, to obtain respective updated location information for each of user devices 210.

As further shown in FIG. 11, if the first user device is not located within the quiet zone (BLOCK 1150—NO), process 1100 may include providing a proximity alert to first user device indicating that third user device is within the proximity radius (BLOCK 1155). For example, application server 240 may determine whether first user device 210 is located within the quiet zone by determining whether the location of first user device 210 is located within a geographical area that is covered by the quiet zone. Based on a determination that first user device 210 is not located within the quiet zone, application server 240 may not preclude proximity alerts to be sent to first user device 210. Application server 240 may provide, to first user device 210, a proximity alert indicating that third user device 210 is within the proximity radius of first user device 210. Application server 240 may also, or alternatively, provide location information, associated with third user device 210, to first user device 210 if application server 240 determines, in a manner similar to that described above (e.g., with respect blocks 715-755 of FIG. 7), that the communication state of third user device 210 permits the location information to be provided to first user device 210.

As yet further shown in FIG. 11, if the first user device is located within the quiet zone (BLOCK 1150—YES) and if the third user device is excepted from the quiet zone (BLOCK 1160-YES), process 1100 may include providing a proximity alert to first user device indicating that third user device is within the proximity radius (BLOCK 1155). For example, application server 240 may determine that the location of the first user device 210 is located within the geographical area that corresponds to the quiet zone base (e.g., based on the location and proximity radius of the quiet zone). Based on the determination that first user device 210 is located within the quiet zone, application server 240 may not preclude proximity alerts from being sent to first user device 210 except for any user device 210, identified by the information associated with the quiet zone, that is excepted from the quiet zone.

Application server 240 may communicate with database 245 to obtain context information, associated with third user device 210, from which information associated with third user device 210 (e.g., an MDN, an IP address, a MAC address, an ESN, a SIM URI, an IMSI etc.) and/or information associated with a user of third user device 210 (e.g., a name, address, username, etc.) can be obtained. Application server 240 may determine whether the information associated with third user device 210 and/or the information associated with the user matches information associated with the excepted user device 210 and/or information associated with the excepted contact, respectively, identified in the information associated with the quiet zone. In the event that application server 240 determines that the information associated with third user device 210 and/or the information associated with the user matches the information associated with the excepted user device 210 and/or the information associated with the excepted contact, respectively, application server 240 may provide, to first user device 210, a proximity alert indicating that third user device is within the proximity radius of first user device 210.

As also shown in FIG. 11, if the first user device is located within the quiet zone (BLOCK 1150—YES) and if the third user device is not excepted from the quiet zone (BLOCK 1160—NO), process 1100 may preclude providing the proximity alert to first user device (BLOCK 1165). For example, application server 240 may determine that the location of the first user device 210 is located within the geographical area that corresponds to the quiet zone (e.g., based on the location and proximity radius of the quiet zone). Based on the determination that first user device 210 is located within the quiet zone, application server 240 may determine whether the information associated with third user device 210 and/or the information associated with the user matches information associated with the excepted user device 210 and/or information associated with the excepted contact, respectively. In the event that application server 240 determines that the information associated with third user device 210 and/or the information associated with the user does not match the information associated with the excepted user device 210 and/or the information associated with the excepted contact, respectively, application server 240 may not provide, to first user device 210, the proximity alert indicating that third user device is within the proximity radius of first user device 210.

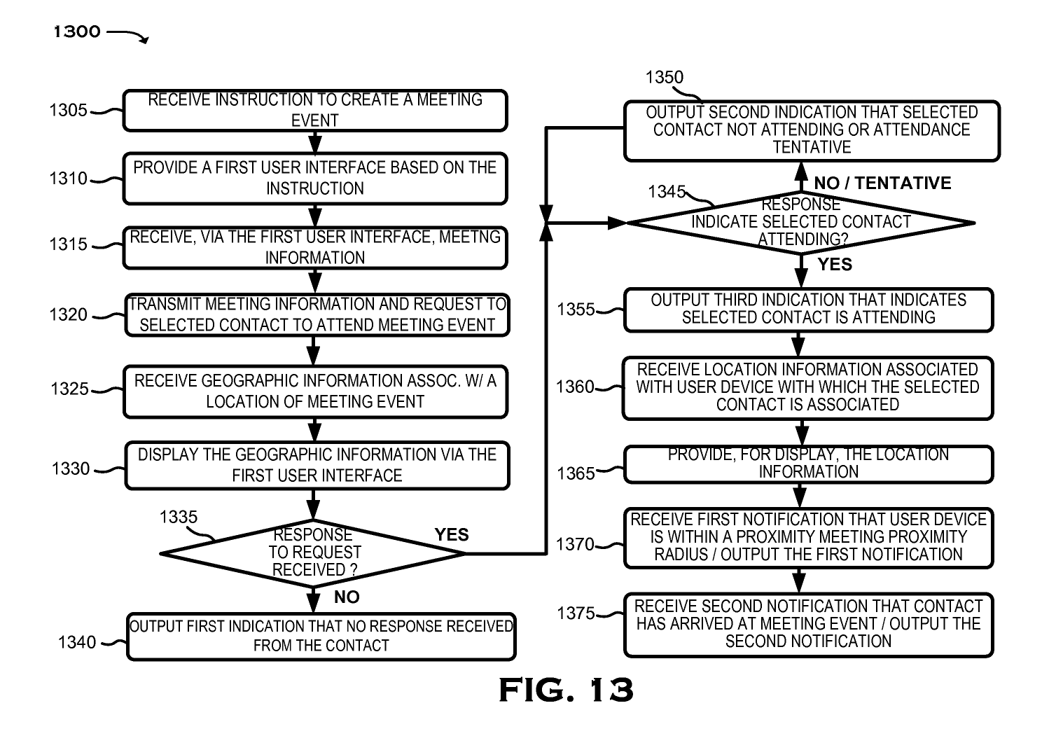

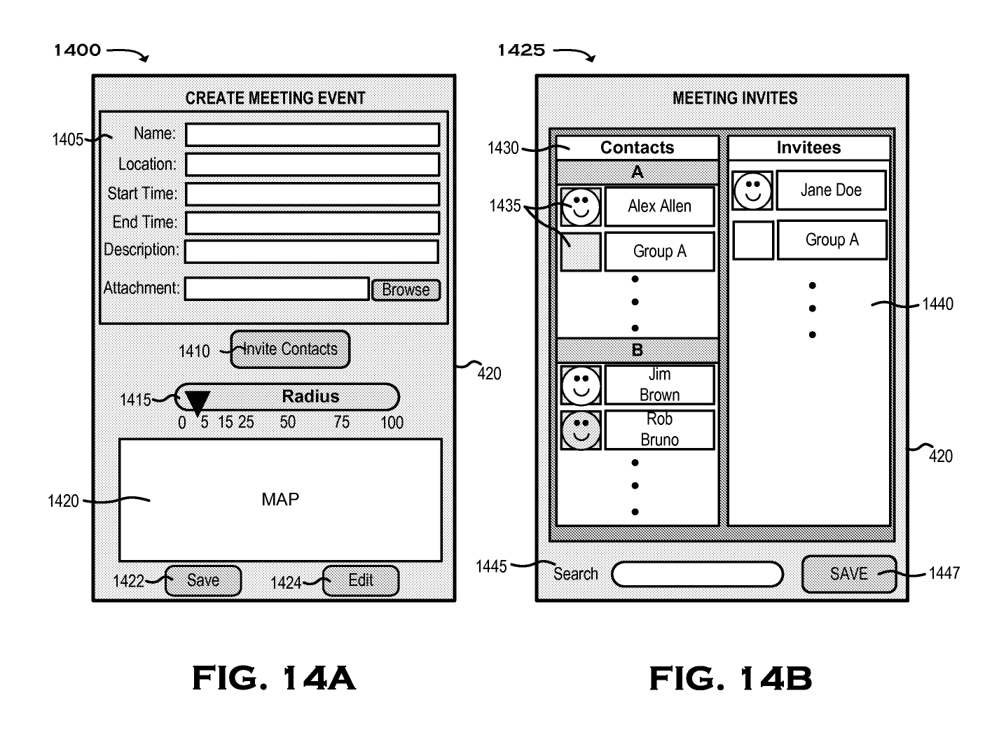

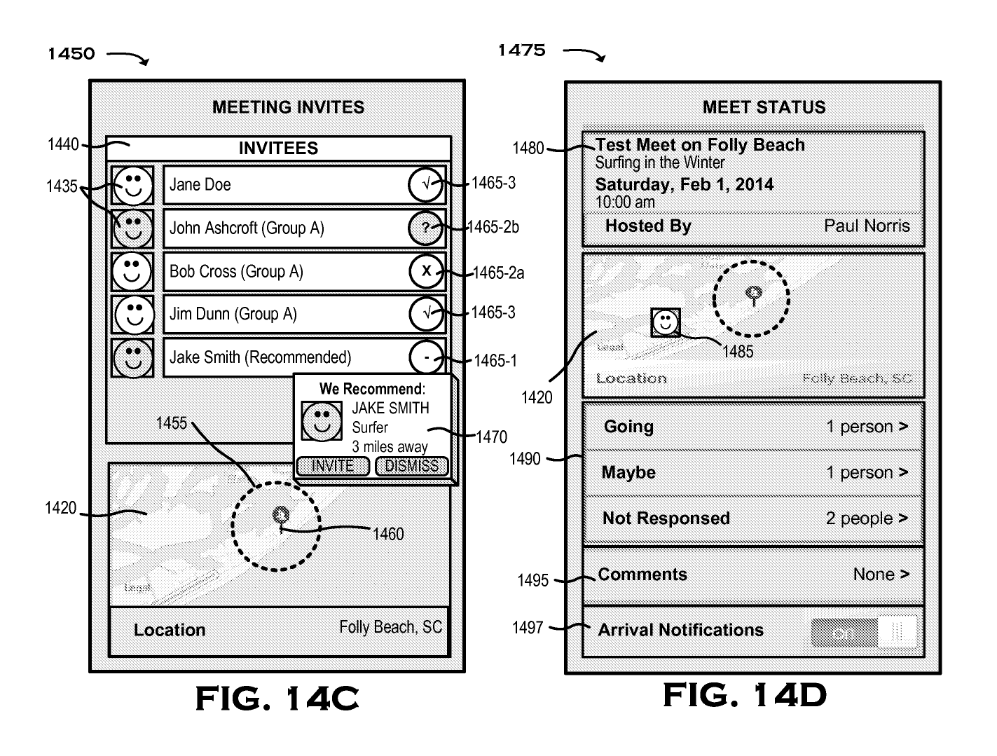

FIG. 13 is a flow chart of an example process 1300 to create, track, and/or manage a meeting event according to an implementation described herein. Process 1300 may be performed by application server 240 and/or user device 210. Additionally, or alternatively, some or all of process 1300 may be performed by a device or a collection of devices separate from, or in combination with, application server 240 and/or user device 210. FIGS. 14A through 14D are example user interfaces 1400 through 1475 that can be used to create, track, or manage a meeting event created by user device 210. All or a portion of process 1300 of FIG. 13 will be described with references to user interfaces 1400 through 1475 of FIGS. 14A through 14D, respectively.

As shown in FIG. 13, process 1300 may include receiving an instruction to create a meeting event (BLOCK 1305) and providing a first user interface based on the instruction (BLOCK 1310). For example, a user of user device 210 may desire to create a meeting event and may cause the CPRA application to provide a one or more user interfaces (e.g., user interface 1400 of FIG. 14A and/or user interface 1425 of FIG. 14B) for display on user device 210 that enables the user to enter information associated with the meeting event.

As shown in FIG. 14A, user interface 1400 may include a collection of fields and/or buttons, such as a meeting identifier field 1405, an invite contacts button 1410, a meeting radius field 1415, a map field 1420, a save button 1422, and an edit button 1424. User interface 1400 may include fields and/or buttons 1405-1424 for explanatory purposes. In practice, user interface 1400 may include additional fields and/or buttons, fewer fields and/or buttons, different fields and/or buttons, and/or differently arranged fields and/or buttons than are described with respect to user interface 1400.

Meeting identifier field 1405 may enable the user to enter information to identify the meeting event (e.g., by name, identifier, etc.), set a location (e.g., address, map coordinates, latitude and/or longitude, etc.), set a date and/or time when the meeting starts and/or ends, describe a purpose or subject matter for the meeting event, upload documents or information (e.g., an image, agenda, etc.). The CPRA application may also, or alternatively, cause a pop up window to be displayed (not shown in FIG. 14A) that includes a calendar that permits the user to select (e.g., by pressing one or more buttons on a keyboard, a pointing device, by touching a screen, etc.) a year, month, day, time, etc. on which to schedule the meeting event. Invite contacts button 1410, when selected by the user, may cause a second user interface to be displayed (to be described below) that includes a list of contacts that permits the user to select a contact to which an invitation is to be provided. Meeting proximity radius field 1415 may permit the user to set a radius, dimension, and/or arrival time of a zone associated with the meeting event based on the user-specified location of the meeting event. Map field 1420 may include information associated with a geographical area in which the meeting event or zone associated therewith is to occur. Save button 1422 may, when selected by the user, enable meeting information, entered via user interface 1400, to be received by user device 1210 and/or transmitted to application server 240. Edit button 1424, when selected by the user, may enable the user to change the meeting information.

As shown in FIG. 14B, user interface 1425 may include a collection of fields and/or buttons, such as a contacts list field 1430, a group of contact fields 1435 (hereinafter referred to collectively as “contact fields 435” and individually, as a “contact field 435”), a list of an invitees field 1440, a search field 1445, and a save button 1447. User interface 1425 may include fields and/or buttons 1430-1447 for explanatory purposes. In practice, user interface 1425 may include additional fields and/or buttons; fewer fields and/or buttons; different fields and/or buttons; and/or differently arranged fields and/or buttons than are described with respect to user interface 1425.

Contacts list field 1430 may include a list of contacts associated with a user of user device 210 and/or one or more user devices 210, associated with a public group and/or private group, to which user device 210 is a member. Contact field 1435 may identify a contact (e.g., Alex Alan, Group A, etc.) and/or a particular user device 210, with which the contact is associated, within contacts list field 1430. In one example, contact field 1435 may correspond to a group of contacts (e.g., Group A), that, if selected by the user, causes each individual contact, within the group, to be displayed as an individual contact field 1435. List of invitees field 1440 may identify each contact field 1435 that is selected by the user. In one example, the user may select a particular contact field 1435 (e.g., by pressing one or more buttons on a keyboard, a pointing device, by touching a screen, etc.) and, in on example, may drag the selected contact field 1435 into the list of invitees field 1440 and/or the CPRA application may automatically cause the selected contact field 1435 to appear in the list of invitees field 1440 (e.g., without dragging selected contact field 1435). Search field 1445 may enable the user to search for a particular contact by entering information associated with the particular contact. Save button 1447, when selected by the user, may cause the each contact, within list of invitees field 1440, to be included within the meeting information and/or may cause user interface 1400 to be displayed.

Returning now to FIG. 13, process 1300 may include receiving, via the first user interface, meeting information (BLOCK 1315) and transmitting the meeting information and a request for a selected contact to attend the meeting event (BLOCK 1320). For example, the user may enter meeting information into the first user interface (e.g., user interface 1400 of FIG. 14A and/or user interface 1425 of FIG. 14B) and user device 210 may receive the meeting information (e.g., when the user selects save button 1424 of FIG. 14A).

By way of example, the user may enter into identifier field 1405 (FIG. 14A) a name of the meeting (e.g., “surfing at Folly Beach”), a location of the meeting event (e.g., a particular address, latitude, longitude, map grid coordinate, etc. associated with Folly Beach), and/or a time at which the meeting event is to start and/or end. The user may also, or alternatively, enter a description and/or keywords that describe the meeting (e.g., “Folly Beach Surf Group Tryouts,” “surfing,” surf,” etc.), and/or upload a document associated with the meeting (e.g., an agenda for the tryouts, images, pamphlets, etc.). The user may select invite contacts button 140 (FIG. 14A) (e.g., by pressing one or more buttons on a keyboard, a pointing device, by touching a screen, etc.) and may view a list of contacts within contacts list field 1430 (FIG. 14B) from which the user may select (e.g., by pressing one or more buttons on a keyboard, a pointing device, by touching a screen, etc.) and/or drag a particular contact field 1435 (FIG. 14B) into list of invitees field 1440 (FIG. 14B). The user may select save button 1447 and may set a proximity radius of a zone associated with the meeting, which may control a distance and/or arrival time, of an invitee, at which a notification is to be provided to user device 210. The user may select save button 1424 (FIG. 14A), which may cause user device 210 to receive the meeting information. User device 210 may transmit the meeting information to application server 240. The meeting information may also, or alternatively, include a request for a particular user device 210, with which the selected contact (appearing on list of invitees field 1440 of FIG. 14B) is associated, to attend the meeting event.

Application server 240 may receive the meeting information and may transmit, to the particular user device 210 (and/or one or more member user devices 210 associated with a public or private group), a request to attend the meeting. The request may include at least a portion of the meeting information (e.g., corresponding to the information entered into meeting identifier field 1405 of FIG. 14A). Additionally, or alternatively, application server 240 may obtain information associated with a geographical area (e.g., information associated with terrain, political subdivisions, transportation routes, traffic congestion, weather conditions, news reports, etc.) in which the meeting is located and may provide, as geographical information, the information, associated with the geographical area, to user device 210. Application server 240 may, for example, communicate with one or more content servers 265 that information and/or services associated with geographical mapping information, weather forecasts, traffic reports, etc.) Application server 240 may also, or alternatively, provide an indication that the request, to attend the meeting event, was sent to the particular user device 210 with which the selected contact is associated.

As further shown in FIG. 13, process 1300 may include receiving geographical information associated with the meeting event (BLOCK 1325) and displaying the geographic information via the first user interface (BLOCK 1330). For example, user device 210 may receive the geographical information from application server 240 and may provide, for display on user device 210, the geographical information via the first user interface (e.g., via map field 1420 of FIG. 14A) and/or some other user interface (e.g., user interface 1450 of FIG. 14C).

As yet further shown in FIG. 13, if a response to the request is not received (BLOCK 1335—NO), process 700 may include outputting a first indication that no response is received from the selected contact (BLOCK 1340). For example, in the event that user device 210 does not receive, from application server 240, a response to the request for the selected contact to attend the meeting, user device 210 may output a first indication that no response from the selected contact has been received. The first indication may, for example, be provided via the first user interface and/or via some other user interface (e.g., user interface 1450 of FIG. 14C) displayed on user device 210.

As also shown in FIG. 13, if a response to the request is received (BLOCK 1335—YES) and if the response indicates that the selected contact is not attending or is tentatively attending (BLOCK 1345—NO/TENTATIVE), process 700 may include outputting a second indication that the selected contact is not attending or that attendance is tentative (BLOCK 1350). For example, application server 240 may receive, from the particular user device 210 with which the selected contact is associated, a response to the request to attend the meeting. Application server 240 may transmit the response to user device 210. User device 210 may receive the response, from application server 240, and may determine, from the response, whether the selected contact is attending the meeting. In the event that user device 210 determines, based on the response, that the selected contact is not attending the meeting, user device 210 may output a second indication that the selected contact is not attending the meeting. Alternatively, in the event that user device 210 determines, based on the response, that the attendance of the selected contact is tentative, user device 210 may output the second indication indicating that the attendance of the selected contact is tentative. The second indication may, for example, be provided via the first user interface and/or via some other user interface (e.g., user interface 1450 of FIG. 14C) displayed on user device 210. User device 210 may continue to monitor whether an updated response is received, from application server 240, that indicates that the response from the selected contact has changed.

As further shown in FIG. 13, if the response indicates that the selected contact is attending (BLOCK 1345—YES), process 700 may include outputting a third indication that the selected contact is attending (BLOCK 1355). For example, in the event that user device 210 determines, based on the response, that the selected contact is attending the meeting, user device 210 may output a third indication that the selected contact is attending the meeting. The third indication may, for example, be provided via the first user interface and/or via some other user interface (e.g., user interface 1450 of FIG. 14C) displayed on user device 210.

For example, as illustrated in FIG. 14C, user interface 1450 may include a collection of fields described above with respect to FIGS. 14A and 14B, such as list of invitees field 1440, contact fields 1435, and map field 1420 as well as a meeting zone object 1455, a meeting location object 1460, a group of response indication objects 1465-1, . . . , 1465-3 (hereinafter, collectively referred to as “indication objects 1465” and individually as a “indication object 1465”), and a recommendation window 1470. User interface 1450 may include fields, windows and/or objects 1455-1470 for explanatory purposes. In practice, user interface 1450 may include additional fields, windows and/or objects; fewer fields, windows and/or objects; different fields, windows and/or objects; and/or differently arranged fields, windows and/or objects than are described with respect to user interface 1450.

Meeting zone object 1455 may identify, within map field 1420, a perimeter of a meeting zone, associated with the meeting event, based on the proximity radius of the meeting zone specified by the user of user device 210. Meeting location object 1460 may identify a location, within map 1420, at which the meeting event is to occur and/or an approximate center location of the meeting zone. Indication object 1465 may include an icon, symbol, logo, shape, character, string, etc. and or appearance based on the indication that is output by user device 210. By way of a non-limiting example, in the event that a response to the request to attend the meeting is not received, user device 210 may output a first indication object 1465 (e.g., such as a dash “-” corresponding to indication object 1465-1 and/or some other object); when the response is not accepted, user device 210 may output a second indication object 1465 (e.g., such as a “X” corresponding to indication object 1465-2a and/or some other object); when the response is tentatively accepted user device 210 may output a third indication object 1465 (e.g., such as a “?” corresponding to indication object 1465-2b and/or some other object); when the response is accepted, user device 210 may output a fourth indication object 1465 (e.g., such as a “√” corresponding to indication object 1465-3 and/or some other object); etc.

Recommendation window 1470 may include information associated with a user (e.g., an image of the user, Jake Smith, Surfer, 3 miles away, etc.), associated with a different user device 210, that is not identified in list of contacts field 1430 (FIG. 14B) and/or list of invitees field 1440. Recommendation window 1470 may also include an invite button and a dismiss button. Invite button may, when selected by the user, permit the user to invite the recommended user. Dismiss button may, when selected by the user, cause recommendation window 1470 to close. For example, application server 240 may, in a manner to be described in greater detail below with respect to FIG. 15, provide a recommendation to user device 210 that identifies a recommended user device 210 and/or a recommended user associated with recommended user device 210. The recommendation may be based on a measure of relevance between context information associated with recommended user device 210 and the meeting information (e.g., name, description, keywords, context information associated with another invitee user device 210, etc.) and/or information associated with a public and/or private group (e.g., group name, a description of the group, context information associated with a member user device 210, membership criteria, etc.) in the case in which the meeting event is associated with such a group. In the event that the user, of user device 210, selects the invite button, the CPRA application may cause the invited contact to appear in invitees list 1440 as a recommended invitee (e.g., shown as Jake Smith (recommended)). In the event that the user selects the dismiss button, the CPRA application may cause recommendation window 1470 to close and/or may preclude the recommended invitee from appearing in invitees list 1440.

As further shown in FIG. 13, process 1300 may include receiving location information associated with a user device with which the selected contact is associated (BLOCK 1360) provide, for display, the location information (BLOCK 1365). For example, application server 240 may obtain location information associated with the particular user device 210 with which the selected contact is associated and may provide the location information to user device 210. The location information may be obtained from the particular user device 210 and/or from base station 220 via which the particular user device 210 is communicating provided that the particular user device 210 is not in an offline communication state.

Additionally, or alternatively, application server 240 may identify a time and/or date at which the meeting is to occur based on the meeting information (hereinafter, the “meeting time”). Application server 240 may also, or alternatively, determine an amount of time before the meeting starts based on a time period between a current time and the meeting time. If the time period is greater than a predetermined threshold, application server 240 may not obtain the location information, which may reduce the amount of processing and/or bandwidth resources used to obtain the location information prior to the meeting. If, however, the time period is less than or equal to the threshold, application server 240 may obtain the location information associated with the particular user device 210. The threshold may be predetermined by an operator of application server 240, may be preprogrammed into CPRA application and/or may be set by the user, of user device 210.

User device 210 may receive the location information and may provide, for display on user device 210, the location information associated with the particular user device 210. In this example, application server 240 may, in a manner similar to that described above with respect to blocks 715-750 of FIG. 7, determine that a communication state, associated with the particular user device 210, permits the location information to be provided to user device 210 (e.g., when the communication state is in the visible state and plugged in to user device 210 and/or in a fully visible state). Additionally, or alternatively, application server 240 may determine whether the particular user device 210 is a member of a public or private group with which the meeting event is associated. In the event that the particular user device 210 is a member of the group, application server 240 may provide the location information to user device 210.

Additionally, or alternatively, application server 240 may determine that the communication state, associated with the particular user device 210, does not permit the location information to be provided to user device 210 (e.g., when the communication state is in an invisible state or a visible state and unplugged from user device 210). In this example, application server 240 may not provide the location information to user device 210. In the event that particular user device 210 is not a member of the group, application server 240 may also, or alternatively, not provide the location information to user device 210.

User device 210 may provide the location information, for display via a user interface (e.g., use interface 1475 of FIG. 14D), that enables the user to monitor the meeting event. For example, as illustrated in FIG. 14D, user interface 1475 may include a map field 1420 as described above with respect to FIG. 14A, as well as a collection of fields and buttons, such as a meeting description field 1485, a location window field 1480, an attendance status field 1485, a comments field 1490, and a arrival notifications button 1495. User interface 1475 may include fields and/or buttons 1480-1497 for explanatory purposes. In practice, user interface 1475 may include additional fields and/or buttons, fewer fields and/or buttons, different fields and/or buttons, and/or differently arranged fields and/or buttons than are described with respect to user interface 1475.

Meeting description field 1485 may include meeting information entered via meeting identifier field 1405 of FIG. 14A. For example, meeting description field 1485 may include information (e.g., the name of the meeting, the date and time of the meeting, a description of the meeting, etc.) entered into user interface 1425 (FIG. 14A) by the user, of user device 210, when creating the meeting event. Location window field 1480 may include a popup window that identifies a location of a user device 210 that is invited to the meeting identified in meeting description field 1485. For example, location window field 1480 may include contact information associated with the selected candidate at a location, within map field 1420, that corresponds to the location of the particular user device 210 obtained from the location information received from application server 240. Attendance status field 1485 may identify a status of responses from user devices 210 to which requests, to attend the meeting event, are sent. For example, attendance status field 1485 may identify invitees that are attending, tentatively attending, not attending or that have not responded in a manner similar to that described above with respect to FIG. 14C. Comments button 1490, when selected by a user, may identify messages (e.g., email messages, instant messages, SMS messages, etc.) that have been sent or received by one or more user devices 210 that have received requests to attend the meeting event. For example, the user, of user device 210, may select comments button 1490, which may display the list of messages and/or enable the user to send and/or receive a message associated with the meeting event.

Arrival notifications button 1495 may permit the user to enable or disable receiving notifications that indicate that a user device 210, to which a request to attend the meeting event is sent, is within the meeting proximity radius and/or has arrived at the meeting location.

As yet further shown in FIG. 13, process 1300 may include receiving a first notification that the user device is within the meeting proximity radius and output the first notification (BLOCK 1370), and receive second notification that the selected contact has arrived at the meeting event and output the second notification (BLOCK 1375). For example, application server 240 may, based on the location information associated with the particular user device 210, determine that the particular user device 210 is within the proximity radius associated with the meeting event and may transmit, to user device 210, a first notification that the particular user device 210 is located within the meeting zone. User device 210 may receive the first notification and may output another first notification that indicates that the particular user device 210 is located within the meeting zone.

Additionally, or alternatively, application server 240 may determine that the location, of the particular user device 210, matches the location of the meeting event that is identifies by the meeting information received from user device 210. Based on the determination that the location of the particular user device 210 matches the location of the meeting event, application server 240 may transmit a second notification, to user device, that indicates that the particular user device 210 has arrived at the meeting event. User device 210 may receive the second notification and may output another second notification that indicates that the particular user device 210 has arrived at the meeting.

Additionally, or alternatively, application server 240 may detect an uninvited user device 210, associated with an uninvited user, within the proximity radius of the meeting event. Application server 240 may, in a manner similar to that described below (e.g. with respect to FIG. 15), determine a measure of relevance between context information associated with the uninvited user device 210 and the meeting information, information associated with a group (e.g., in the case when the meeting event is associated with a public or private group), and/or context information associated with an invited user device 210 and/or a member user device 210 associated with the group. In the event that application server 240 determines that the measure of relevance is greater than a predetermined context threshold (e.g., predetermined by the CPRA application, programmed by an operator of application server 240, etc.), application server 240 may provide, to the uninvited user device 210, a request to attend the meeting event, a request to join the group, and/or advertising content associated with the meeting event, the group, or a business with which the user device 210, that created the meeting event, is associated.

FIG. 15 is a flowchart of an example process 1500 to identify a measure of relevance for use in determining whether to invite, and/or provide content to, user device 210 according to an implementation described herein. Process 1500 may be performed by application server 240 and/or user device 210. Additionally, or alternatively, some or all of process 1500 may be performed by a device or a collection of devices separate from, or in combination with, application server 240 and/or user device 210.

As shown in FIG. 15, process 1500 may include receiving an instruction, from a first user device, to determine a measures of relevance of one or more second user devices (BLOCK 1505) and obtaining, based on the instruction, location information and context information associated with the second user devices (BLOCK 1510). For example, first user device 210 may be performing an operation to set up a meeting event and may provide event information to application server 240 (e.g., in a manner similar to that described above with respect to process 1300 of FIG. 13). Additionally, or alternatively, first user device 210 may be performing an operation to associate one or more contacts and may provide registration information to application server 240 in a manner similar to that described above with respect to process 500 of FIG. 5). Application server 240 may receive the meeting information and/or the registration information and may determine whether to provide, to first user device 210, content and/or a recommendation to invite one or more second user devices 210 to be associated with first user device 210 and/or to attend the meeting event. The content information may, for example, include advertising content, promotional information, discount offers, etc. associated with the meeting event, a public or private group with which the meeting even is associated, and/or a business entity with which first user device 210 is associated)

Application server 240 may, in a manner described above, obtain location information associated with second user devices 210 that are known to be located (e.g., based on user addresses, subscription information, etc. obtained from HSS/AAA server 255) within a predetermined geographical area (e.g., within the boundaries of a state or group of states, a zip code or group of zip codes, an area code or group of area codes, etc.) or distance of first user device 210 and/or a location of the meeting event. Additionally, or alternatively, application server 240 may obtain context information, associated with the second user devices 210, from database 245. The context information may be obtained based on information associated with second user devices 210 (e.g., an MDN, MAC address, IP address, IMSI, SIM URI, ESN, etc.) obtained from HSS/AAA server 255.

As also shown in FIG. 15, process 1500 may include determining distances between the second user devices and a location associated with the first user device based on the location information (BLOCK 1515) and selecting one or more of the second user devices based on the distances (BLOCK 1520). For example, application server 240 may, in a manner similar to that described above (e.g., with respect to Block 735 of FIG. 7), use the location information to determine a respective distance and/or estimated travel between each of the second user devices 210 and a location of first user device 210 and/or a location of the meeting event. Application server 240 may select one or more of second user devices 210 based on the distances and/or estimated travel times. For example, application server 240 may select any of second user devices 210 associated with a distance that is less than a first threshold (e.g., 2, 5, 10, 20, 50, 100, 1000, miles, etc.). Additionally, or alternatively, application server 240 may select any of second user devices 210 associated with an estimated travel time that is less than a second threshold (e.g., 5 mins., 10 mins., 30 mins., 1 hr., 2 hrs. 6 hrs. 12 hrs., etc.). Additionally, or alternatively, application server 240 may rank the second user devices 240 based on the distances and/or estimated travel times (e.g., from shortest distance and/or travel time to longest distance and/or travel time, vice versa, or some other ranking scheme) and may select none, some, or all of second user devices 210 based on the shortest distances and/or travel times.

As further shown in FIG. 15, process 1500 may include determining measures of relevance between the context information, associated with selected second user devices and meeting information specified by a user of first user device (BLOCK 1525) and determining scores for selected second user devices based on the distances and the measures of relevance (BLOCK 1530). For example, application server 240 may compare the context information, associated with each of the selected second user devices 210, to the meeting information received from first user device 210 to determine a degree to which the context information matches the meeting information. The meeting information may include information that was entered by the user of first user device 210, via a user interface (e.g., user interface 1400 of FIG. 14A), in a manner similar to that described above (e.g., with respect to FIG. 13). Such meeting information may also, or alternatively, include information that describes a business entity with which user device 210 is associated, a public or private group with which first user device is a member, and/or context information associated with one or more third user devices 210 associated with the business entity or group and/or to which a request to attend the meeting event has been sent. For example, application server 240 may identify one or more preferences specified by each user of respective second user devices 210, such as user hobbies, interests, browsing habits, purchase histories, entertainment genres, religious affiliations, etc. identified in the context information for each second user device 210 to determine a quantity of the preferences that match one or more meeting parameters identified in the meeting information (sometimes referred to herein as a “degree of match”), such as keywords associated with the meeting event, user-specified subject matter and/or description of the meeting event (e.g., book club, a public or private group, a business entity, surfing club, bible study group, a fantasy football league, etc.), the location of the meeting event (e.g., at a beach, a particular church or school, a particular restaurant, etc.), context information associated with one or more third user devices 210. Application server 240 may assign a first score to each second user device 210 based on the quantity of preferences that match the parameters set forth in the meeting information.

Additionally, or alternatively, application server 240 may compare the context information, associated with each of the second user devices 210, to the context information, associated with the first user device 210 to determine the quantity of preferences, of each of the second user devices 210, that match preferences of first user device 210. Application may assign a second score to each of second user devices 210 based on the degree of match between the preferences of each second user device 210 and the preferences of first user device 210. The degree of match reflected in the scores may correspond to a measure of relevance between the preferences of a user of second user device 210 and the description and/or subject matter of the meeting event and/or the preferences of the user of first user device 210.

Additionally, or alternatively, application server 240 may determine the measure of relevance based on individual rank, score, or combined score of each of the second user devices 210. The combined score may correspond to any combination of two or more of the respective distances, respective first scores, and/or respective second scores.

As yet further shown in FIG. 15, process 1500 may include identifying a selected second user device based on the scores (BLOCK 1535) and providing a recommendation, to first user device, to invite or associate the identified second user device (BLOCK 1540). Application server 240 may rank the second user devices 210 based on the distances, the first scores, the second scores, or the combined scores. Application server 240 may also, or alternatively, identify none, some, or all of second user devices 210 based on the respective measures of relevance of each second user device 210. For example, application server 240 may identify a particular second user device 210, associated with the highest measure of relevance, based on distance, a score, or a combined score of the particular user device 210 (e.g., shortest distance and/or highest degree of match, etc.). Additionally, or alternatively, application server 240 may identify one or more of the second user devices 210 with the highest measures of relevance based on distances, scores, and/or combined scores of the group of second user devices 210 relative to all of the selected second user devices 210 (e.g., the top 2, 5, 10, etc. shortest distances and/or top 2, 5, 10, etc. highest degrees of match, etc.). Additionally, or alternatively, application server 240 may identify a one or more second user devices 210 associated with a measure of relevance that is greater than a predetermined threshold (e.g., predetermined by the CPRA application and/or an operator of application server 240).

Application server 240 may transmit, to first user device 210, a notification that recommends the selected one or more second user devices 210. First user device 210 may receive the notification and may output a notification that enables a user, of first user device 210, to consider whether to associate a recommended second user device 210 and/or transmit a request to invite a recommended second user device 210 to a meeting event. Additionally, or alternatively, application server 240 may automatically transmit, to the selected one or more second user devices 210, a request to attend a meeting event. Additionally, or alternatively, first user device 210 and/or application server 240 may provide, to the selected one or more second user devices 210 advertising content, promotional materials, discount offers, etc., associated with the meeting event, a business with which first user device 210 is associated, a public or private group, etc.

Systems and/or methods, described herein, may enable a user device 210 and/or application server 240 to create, track, and/or manage a meeting event at a location and/or time that is specified by a user of user device 210. User device 210 and/or application server 240 may use a CPRA application to dynamically identify and track the relative location, distance, arrival times, communications with, user intentions, environmental conditions (e.g., traffic, weather, etc.) associated with another user device 210.

The systems and/or methods may enable a first user device 210 to create, monitor, and/or control a meeting event. The systems and/or methods may enable first user device 210 and/or application server 240, using the CPRA application, to dynamically determine, track, and/or provide updates, to the first user device 210, regarding the location of second user device 210 relative to the location, geographic area, and/or time associated with the meeting event.

The systems and/or methods may also, or alternatively, enable a server device to provide a notification (hereinafter referred to as a “proximity alert”) to a first user device when a second user device is within a certain distance from and/or travel time to the first user device based on a user-specified proximity setting (e.g., distance, radius, time, boundary, perimeter, etc.) relative to a location of the first user device.

The systems and/or methods may also, or alternatively, enable a user device and/or server device, using the CPRA application, to create a zone, associated with a user-specified geographic area, that enables the user device to receive notifications when a selected other user device enters or exits the geographical area

The systems and/or methods may also, or alternatively, enable user device 210 and/or application server 240, using the CPRA application, to create a quiet zone, based on a user-specified geographic area, that precludes proximity alerts and/or other information (e.g., location information, messages, etc.) from being received from non-excepted user devices that enter or exit the geographic area. Such a quiet zone may avoid the potential nuisance of repeatedly receiving proximity alerts under conditions that the user does not desire to receive such alerts.

The systems and/or methods may also, or alternatively, enable user device 210 and/or application server 240 to obtain context information, associated another user device 210. The systems and/or methods may, for example, compare context information, associated with second user device 210, to context information associated with first user device 210 and/or meeting information, specified by a user of first user device 210, to determine a degree of match and/or a measure of relevance of the context information associated with second user device 210. The systems and/or methods may use the measure of relevance to determine whether to recommend, to first user device 210, that the second user device 210 be associated with first user device 210 and/or receive a request to attend the meeting event.

The systems and/or methods may enable a communication state, associated with user device 210, to be set and consented to by a user of user device 210. The communication state may permit the user to control the manner in which location information, associated with user device 210, is made available to other user devices 210.

The foregoing description provides illustration and description, but is not intended to be exhaustive or to limit the implementations to the precise form disclosed. Modifications and variations are possible in light of the above teachings or may be acquired from practice of the embodiments.

While series of blocks have been described with regard to FIGS. 5, 7, 11, 14 and 15, the order of the blocks may be modified in other implementations. Further, non-dependent blocks may be performed in parallel.

It will be apparent that systems and methods, as described above, may be implemented in many different forms of software, firmware, and hardware in the implementations illustrated in the figures. The actual software code or specialized control hardware used to implement these systems and methods is not limiting of the implementations. Thus, the operation and behavior of the systems and methods were described without reference to the specific software code—it being understood that software and control hardware can be designed to implement the systems and methods based on the description herein.

Further, certain portions, described above, may be implemented as a component or logic that performs one or more functions. A component or logic, as used herein, may include hardware, such as a processor, an ASIC, or a FPGA, or a combination of hardware and software (e.g., a processor executing software).

It should be emphasized that the terms comprises and comprising, when used in this specification, are taken to specify the presence of stated features, integers, steps or components but do not preclude the presence or addition of one or more other features, integers, steps, components or groups thereof.

Even though particular combinations of features are recited in the claims and/or disclosed in the specification, these combinations are not intended to limit the disclosure of the embodiments. In fact, many of these features may be combined in ways not specifically recited in the claims and/or disclosed in the specification. Although each dependent claim listed below may directly depend on only one other claim, the disclosure of the embodiments includes each dependent claim in combination with every other claim in the claim set.

No element, act, or instruction used in the present application should be construed as critical or essential to the implementations unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
receiving, by a server device and from a first user device, an instruction to create a meeting event, the instruction identifying at least one of:
a second user device that is to be invited to attend the meeting event, or
a geographic area in which the meeting event is to occur,
transmitting, by the server device and to the second user device, a request to attend the meeting event based on receiving the instruction;
identifying, by the server device and based on transmitting the request, a communication state of the second user device, the communication state indicating whether location information, that identifies a location of the second user device, is to be provided to the first user device,
obtaining, by the server device, the location information when the communication state indicates that the location information is to be provided to the first user device;
determining, by the server device and based on the location information, whether the second user device is located within the geographic area, and
transmitting, to the first user device, a notification that indicates that the second user device is located within the geographic area when the second user device is located within the geographic area,
the notification including the location information when the communication state indicates that the location information is permitted to be provided to the first user device.

2. The method of claim 1, further comprising:
receiving, by the server device and from the second user device, a response, to the request, that indicates that the second user device is not attending the meeting event;
transmitting, to the first user device and based on receiving the response, a particular notification that indicates that the second user device is not attending the meeting; and
precluding, by the server device, the location information from being obtained based on the response indicating that the second user device is not attending the meeting event.

3. The method of claim 1, further comprising:
receiving, by the server device and from the second user device, a response, to the request, that indicates that the second user device is attending the meeting event;
transmitting, to the first user device and based on receiving the response, a particular notification that indicates that the second user device is attending the meeting; and
obtaining, by the server device, the location information based on the response indicating that the second user device is attending the meeting event.

4. The method of claim 1, where obtaining the location information further includes:
communicating with the second user device to obtain the location information when the communication state indicates that the location is to be provided to the first user device; or
communicating with a base station, via which the second user device is communicating, to obtain the location information when the communication state indicates that the location is to be provided to the first user device.

5. The method of claim 1, further comprising:
transmitting, to the first user device, the notification, in a manner that does not include the location information, when the communication state indicates that the location information is not to be provided to the first user device.

6. The method of claim 1, further comprising:
determining that the second user device is not located within the geographic area; and
transmitting, to the first user device, the location information in a manner that does not include transmitting the notification based on the determination that the second user device is not located within the geographic area.

7. The method of claim 1, further comprising:
identifying a period of time that is to occur before the meeting event starts, when the event starts being identified by the meeting information;
determining whether the period of time is less than, or equal to, a threshold; and
obtaining the location information when the period of time is less than, or equal to, the threshold

8. The method of claim 7, further comprising:
precluding obtaining the location information when the period of time is not less than or equal to the threshold.

9. The method of claim 1, further comprising:
determining, based on the meeting information, that the meeting event is associated with a group of which one or more third user devices are members; and
transmitting, to the one or more third user devices, the request to attend the meeting event based on the determination that the meeting event is associated with the group.

10. The method of claim 9, further comprising:
obtaining particular location information, associated with the one or more third user devices, based on the determination that the meeting event is associated with the group.

11. A server device, comprising:
one or more processors, executing one or more instructions, to:
receive, from a first user device, an instruction to create a meeting event, the request including meeting information that identifies at least one of:
a second user device to be invited to attend the meeting event,
a distance associated with a location where the meeting event is to occur, or
a time when the meeting is to occur,
transmit, to the second user device, a request to attend the meeting event based on the instruction;
obtain, based on transmitting the request, context information, associated with the second user device, that identifies a communication state of the second user device,
the communication state indicating whether location information, that identifies a location of the second user device, is permitted to be obtained or is permitted to be provided to the first user device,
determine whether an amount of time, before the meeting time, is less than a predetermined threshold when the communication state indicates that the location information is permitted to be obtained,
obtain the location information when the amount of time is less than the threshold,
determine, by the server device and based on the location information, whether the second user device is located within the distance associated with the location, and
transmit, to the first user device, a notification that indicates that the second user device is located within the distance when the second user device is located within the distance,
the notification including the location information when the communication state indicates that the location information is permitted to be provided to the first user device.

12. The server device of claim 11, where the one or more processors are further to:
receive, from the second user, a particular instruction to permit the location information to be provided to the first user device,
update the communication state to indicate that the location information is permitted to be provided, to the first user device, based on the particular instruction, and
transmit the location information, to the first user device, based on updating the communication state.

13. The server device of claim 11, where the one or more processors are further to:
receive, from the second user, a particular instruction to permit the location information to be obtained and not to permit the location information to be provided to the first user device,
update the communication state, based on the particular instruction, to indicate that the location information is permitted to be obtained and is not permitted to be provided to the first user device, and
transmit the location information, to the first user device, based on updating the communication state.

14. The server device of claim 11, where the one or more processors are further to:
determine that the second user device is not within the distance associated with the location of the meeting event, and
transmit, to the first user device, the location information in a manner that does not include transmitting the notification, when the communication state indicates that the location information is permitted to be provided to the first user device.

15. The server device of claim 11, where the one or more processors are further to:
determine that the amount of time is not less than the threshold, and
preclude obtaining the location information when the amount of time is not less than the threshold.

16. The server device of claim 11, where the communication state includes at least one of:
a first state that precludes the location information from being obtained from the second user device,
a second state that permits the location information to be obtained and does not permit the location information to be provided to any other user device,
a third state that permits the location information to be obtained and does not permit the location information to be provided to the first user device,
a fourth state that permits the location information to be obtained and permits the location information to be provided to the first user device when the user, of the second user device, permits the location information to be provided to the first user device, or
a fifth state that permits the location information to be obtained and permits the location information to be provided to any other user device.

17. The server device of claim 11, where the one or more processors are further to:
identify, based on the meeting information, a contact associated with a user of the first user device, the contact corresponding to one or more third user devices that are associated with a group, and
transmitting, to the one or more third user devices, an invitation, to attend the meeting event, based on identifying the contact.

18. The server device of claim 17, where the one or more processors are further to:
obtain first context information associated with a fourth user device, the first context information identifying first preferences associated with a user of the fourth user device;
obtain second context information associated with at least one third user device of the one or more third user devices, the second context information identifying second preferences associated with a user of the at least one third user device;
comparing the first preferences to the second preferences to identify a quantity of matches between the first preferences and the second preferences;
transmit to the fourth server device, a particular invitation to attend the meeting when the quantity of matches is greater than a threshold.

19. The server device of claim 17, where the one or more processors are further to:
obtain particular context information associated with a fourth user device, the particular context information identifying particular preferences associated with a user of the fourth user device;
obtain information associated with group, the information, associated with the group describing subject matter with which the group is associated;
compare the particular preferences to the information, associated with the group, to identify a quantity of matches between the particular preferences and the information associated with the group;
transmit to the fourth server device, a particular invitation to attend the meeting or join the group when the quantity of matches is greater than a threshold.

20. A non-transitory computer-readable medium containing one or more instructions executable by one or more processors, the computer-readable medium comprising:
one or more instructions to receive, from a first user device, a request to create a zone, the request including zone information that identifies a geographical area associated with the zone;
one or more instructions to determine, based on the zone information, whether a first type of zone or a second type of zone is to be created,
the first type of zone enabling a notification to be provided, to the first user device, when a particular user device is located within the zone, and
the second type of zone precluding the notification from being provided, to the first user device, when the particular user device is located within the geographical area;
one or more instructions to determine that a second user device is located within the geographic area based on determining whether the first type of zone or the second type of zone is to be created;
one or more instructions to determine whether the second user device is identified by the zone information, based on the determination that the second user device is located within the geographic area; and
one or more instructions to provide, to the first user device, the notification, that indicates that the second user device is located within the geographical area, when the second user device is identified by the zone information and when the first type of zone is to be created.

21. The non-transitory computer-readable medium of claim 20, further comprising:
one or more instructions to receive, from the first user device, advertising content associated with a business with which the first user device is associated; and
one or more instructions to provide, to the second user device, the advertising content when the notification is provided to the first user device.

22. The non-transitory computer-readable medium of claim 20, further comprising:
one or more instructions to determine that the second type of zone is to be created based on the zone information;
one or more instructions to determine whether the first user device is located within the geographical area based on determining that the second type of zone is to be created; and
one or more instructions to preclude providing the notification, to the first user device, when the first user device is located within the geographical area.

23. The non-transitory computer-readable medium of claim 22, further comprising:
one or more instructions to determine that a third user device is located within the geographical area;
one or more instructions to identify that the third user device is identified in the zone information; and
one or more instructions to provide, to the first user device, a particular notification, that indicates that the third user device is located within the geographical area, based on the third user being identified in the zone information.

24. The non-transitory computer-readable medium of claim 20, further comprising:
one or more instructions to determine that the second type of zone is to be created based on the zone information;
one or more instructions to determine whether the first user device is not located within the geographical area based on determining that the second type of zone is to be created; and
one or more instructions to monitor a location of the first user device to determine whether the first user device enters the geographical area.

25. The non-transitory computer-readable medium of claim 20, further comprising:
one or more instructions to receive, from the first user device, registration information specified by a user of the first user device, the registration information identifying a first distance in at which the user desires to receive a particular notification when any of a plurality of third user devices are located within the first distance from the first user device;
one or more instructions to determine that a third user device, of the plurality of third user devices, is located at a second distance from the first user device; and
one or more instructions to transmit, to the first user device, the particular notification that indicates that the third user device is within the first distance when the second distance is less than, or equal to, the first distance.

26. A method, comprising:
receiving, by a server device and from a first user device, an instruction to create a meeting event, the instruction including meeting information that identifies at least one of:
a second user device to be invited to attend the meeting event, or
a geographic area in which the meeting event is located;
transmitting, by the server device and to the second user device, a request to attend the meeting event based on receiving the instruction;
determining, by the server device and based on transmitting the request, whether a response, to the request, is received from the second user device;
transmitting, to the first user device, the response when the response is received from the second user device, the response indicating that the second user device is not attending the meeting event, is attending the meeting event, or that attendance at the meeting event is tentative;
determining, by the server device, a communication state associated with the second user device when the response indicates that the second user device is attending the meeting event,
the communication state indicating at least whether location information, that identifies a location of the second user device, is permitted to be obtained;
obtaining, by the server device, the location information when the communication state indicates that the location information is permitted to be obtained by the server device;
determining, by the server device and based on the location information, whether the second user device is located within the geographical area; and
transmitting, to the first user device, a notification that indicates that the second user device is located within the geographical area.

27. The method of claim 26, further comprising:
determining that the communication state does not permit the location information to be obtained; and
monitoring the communication state to detect whether a change occurs with respect to the communication state based on the determination that the communication state does not permit t the location information to be obtained.

28. The method of claim 26, further comprising:
determining that the communication state permits the location information to be provided to the first user device; and
providing, to the first user device, the location information based on the determination that the communication state permits the location information to be provided to the first user device.

29. The method of claim 26, where the communication state includes at least one of:
a first state that precludes the location information from being obtained,
a second state that permits the location information to be obtained and does not permit the location information to be provided to the first user device or any user device,
a third state that permits the location information to be obtained and permits the location information to be sent to the first user device when the user, of the second user device, permits the location information to be provided to the first user device, or
a fourth state that permits the location information to be obtained and permits the location information to be provided to the any user device.

30. The method of claim 26, where the communication state is set by a user of the second user device.

31. The method of claim 26, further comprising:
identifying a period of time that is to occur before a time when the meeting event occurs, the time being identified by the meeting information;
determining whether the period of time is less than, or equal to, a threshold; and
obtaining the location information when the period of time is less than, or equal to, the threshold.

32. The method of claim 26, where obtaining the location information further includes:
communicating with the second user device to obtain the location information; or
communicating with a base station, via which the second user device is communicating, to obtain the location information.

33. The method of claim 26, further comprising:
identifying a first location at which the meeting event is to occur based on the meeting information;
identifying a second location, of the second user device, based on the location information;
determining a distance between the second user device and where the meeting event is located based on a difference between the first location and the second location;
determine whether the distance indicates that the second user device is located within the geographical area; and
outputting, to the first user device, the notification when the distance indicates that the second user device is located within the geographical area.

34. The method of claim 33, further comprising:
determining that the first location matches the second location; and
outputting, to the first user device, a particular notification that the second user device has arrived at the meeting event based on the determination that the first location matches the second location.

35. The method of claim 33, further comprising:
obtaining, from a particular server device, geographical information, associated with the geographical area, the geographical information including information associated with posted speed limits or traffic congestion associated with transportation routes within the geographical area;
determining, based on the geographical information, an estimated speed at which the second user device can travel to the meeting event;
determining an amount of time for the second user device to arrive at the meeting based on the estimated speed and the distance; and
transmit, to the first user device, an indication that the second user device will arrive at the meeting event in the amount of time.

36. The method of claim 26, further comprising:
obtaining first context information associated with a plurality of third user devices, the context information identifying preferences associated with users of the plurality of user devices;
comparing the preferences for each of the plurality of third user devices to a subject or description of the meeting event, identified by the meeting information, to identify a respective quantity of matches between the preferences of each of the plurality of third user devices and the subject or description of the meeting event;
selecting one or more third user devices, of the plurality of third user devices, associated with a highest quantity of matches; and
providing, to the first user device, a recommendation to invite the one or more third user devices to the meeting event.
